(19) United States
(12) Patent Application Publication
(10) Pub. No.: US 2026/0186227 A1
(43) Pub. Date: Jul. 2, 2026

(54) UNIVERSAL MOUNTING MECHANISM FOR MOUNTING A TELECOMMUNICATIONS CHASSIS TO A TELECOMMUNICATIONS FIXTURE

(71) Applicant: CommScope Connectivity Belgium BVBA, Kessel-Lo (BE)

(72) Inventors: Johan GEENS, Bunsbeek (BE); Pieter VERMEULEN, Westerlo (BE); Eric KEUSTERMANS, Houwaart (BE)

(73) Assignee: CommScope Connectivity Belgium BVBA, Kessel-Lo (BE)

(21) Appl. No.: 19/552,763

(22) Filed: Feb. 27, 2026

Related U.S. Application Data
(63) Continuation of application No. 18/650,715, filed on Apr. 30, 2024, now Pat. No. 12,585,076.
Application No. 18/650,715 is a continuation of application No. 17/386,786, filed on Jul. 28, 2021, now Pat. No. 11,982,855.
Application No. 17/386,786 is a continuation of application No. 16/562,735, filed on Sep. 6, 2019, now Pat. No. 11,092,766.
Application No. 16/562,735 is a continuation of application No. 14/787,099, now Pat. No. 10,409,020.
(60) Provisional application No. 61/815,549, filed on Apr. 24, 2013.

(51) Int. Cl. G02B 6/44; B29L 31/00; F16M 13/02

(52) U.S. Cl. CPC G02B 6/4455; F16M 13/02; G02B 6/44; G02B 6/44526; G02B 6/44528; B29L 2031/7752

(57) ABSTRACT

A universal mounting mechanism for mounting a telecommunications chassis to a telecommunications fixture includes a mounting bracket defining a rear portion for mounting to the fixture and a front portion for slidably receiving the chassis, the front portion including a latch opening. A locking spring is configured for mounting to the chassis, the spring configured to flex laterally to snap in to the latch opening. A release handle is configured to be slidably mounted to the chassis, the release handle defining a deflection tab for moving the locking spring out of the latch opening when the handle is slid rearward to forward. A cover is configured to be mounted to the chassis, the cover defining a deflection ramp for interacting with the deflection tab of the handle to move the deflection tab laterally to contact the spring when the release handle is slid.

### CROSS-REFERENCE TO RELATED APPLICATIONS

This application is a Continuation of U.S. patent application Ser. No. 18/650,715, filed Apr. 30, 2024; which is a Continuation of U.S. patent application Ser. No. 17/386,786, filed Jul. 28, 2021, now U.S. Pat. No. 11,982,855; which is a Continuation of U.S. patent application Ser. No. 16/562,735, filed Sep. 6, 2019, now U.S. Pat. No. 11,092,766; which is a Continuation of U.S. patent application Ser. No. 14/787,099, filed Oct. 26, 2015, now U.S. Pat. No. 10,409,020; which is a National Stage of PCT/EP 2014/058136, filed Apr. 22, 2014; which claims benefit of U.S. Provisional Application No. 61/815,549, filed Apr. 24, 2013, and which applications are incorporated herein by reference. To the extent appropriate, a claim of priority is made to each of the above disclosed applications.

### FIELD OF THE INVENTION

The present invention relates to an optical fiber distribution system, including a rack, and elements which populate the rack, including fiber terminations, patching, fiber splitters, and fiber splices.

### BACKGROUND OF THE INVENTION

Optical fiber distribution systems include fiber terminations and other equipment which is typically rack mounted. Various concerns exist for the optical fiber distribution systems, including density, ease of use, and cable management. There is a continuing need for improvements in the optical fiber distribution area.

### SUMMARY OF THE INVENTION

One implementation of a system in accordance with the examples of the disclosure includes a building block element mountable to a rack or other structure. The element includes a chassis and a movable tray. The tray is movably mounted to chassis with a slide mechanism that allows the tray to slide relative to the chassis. The slide mechanism includes a synchronized movement feature for managing the cables extending to and from the tray, such that cable pull at the entry and exit locations is reduced or eliminated as the tray is moved.

One synchronized movement feature includes gears, including a rack and pinion system. Another synchronized movement feature includes wheels and wires.

The tray preferably includes mounting structures for holding cable terminations, splitters, and/or splices. One mounting structure includes an open shaped frame member for connector access. In one example, two frame members are provided, one positioned over the other. For improved access, the frame members are hingedly mounted to the tray. In a termination arrangement, the adapters are arranged so that the connector axes are horizontal and extend in a perpendicular direction to the direction of travel for the tray.

Each frame member can be populated with adapter blocks. Pathways guide cables to the adapter ports of the adapter blocks for fiber optic cables terminated with connectors to be received therein. The cables follow a general S-shaped pathway from a side of each element to the adapter blocks. The S-shaped pathway includes two levels inside of the tray to segregate cables between the two frame members. Various flanges and radius limiters can be provided to assist with cable management.

The elements can be stacked in a column with each tray mounted horizontally, or used in a group or block mounted vertically. In the case of a column of elements, a selected tray is pulled outward to access the desired tray, and then the frame members on the tray can be pivoted as needed.

One side of each element can be for patch cables, and the opposite side can be for cable termination of an incoming cable, such as a distribution cable or a feeder cable. Because of the synchronized movement feature, cables can be secured along the sides of the elements and still allow for sliding movement of the trays without a need for large amounts or any cable slack.

The tray and the frame members allow for easy top and bottom access to connectors on either side of the adapters. Openings are provided in the tray bottom for hand access if desired.

The cable mounts for the distribution cables or feeder cables can be snap mounted to the elements and/or mounted in a longitudinal slide mount, and include strength member clamps and cable clamps.

Groupings of loose cables can be managed with cable wraps or other cable guides such as flexible troughs.

The elements can be configured as desired and form building blocks for an optical fiber distribution system (ODF).

When the elements are mounted in a column in a rack, the cables can be placed in vertical cable guides to enter and exit the selected element.

The example rack is front accessible, however, the elements can be used in other racks, frames, cabinets or boxes including in arrangements where rear access is desirable or useful.

According to another aspect, the disclosure is directed to a universal mounting mechanism configured for mounting a telecommunications chassis to a telecommunications fixture, the mounting mechanism comprising a mounting bracket defining a rear portion configured for mounting to the telecommunications fixture and a front portion configured to slidably receive the telecommunications chassis, the front portion including a latch opening, a locking spring configured to be mounted to the telecommunications chassis, the locking spring defining a portion configured to flex laterally to snap in to the latch opening, a release handle configured to be slidably mounted to the telecommunications chassis, the release handle defining a deflection tab for moving the locking spring out of the latch opening of the mounting bracket when the release handle is slid along a rearward to forward direction with respect to the telecommunications chassis, and a cover configured to be mounted to the telecommunications chassis, the cover defining a deflection ramp configured to interact with the deflection tab of the release handle for moving the deflection tab laterally to contact the locking spring when the release handle is slid with respect to the telecommunications chassis.

According to another aspect, the disclosure is directed to a telecommunications system that includes the universal mounting bracket mounted between the telecommunications chassis and the telecommunications fixture.

According to yet another aspect, the disclosure is directed to a method of releasably mounting a telecommunications chassis to a telecommunications rack. The method comprises mounting a mounting bracket to the telecommunications fixture, the mounting bracket defining a front portion including a latch opening, sliding the front portion of the mounting bracket into a bracket channel defined on at least one side of the telecommunications chassis, laterally flexing a locking spring to snap-fit at least a portion of the locking spring into the latch opening, and pulling a release handle on the telecommunications chassis along a rearward to forward direction to deflect the locking spring out of the latch opening.

### BRIEF DESCRIPTION OF THE FIGURES

FIG. 1 is a perspective view of a first embodiment of an optical fiber distribution element in accordance with aspects of the present disclosure.

FIG. 2 is a top view of the element of FIG. 1.

FIG. 3 is a perspective view of the element of FIG. 1 showing the tray pulled forward from the chassis.

FIG. 4 shows one of the tray frame members pivoted upwardly from the tray.

FIG. 5 shows a second frame member pivoted upwardly relative to the tray.

FIG. 6 shows a portion of a cable management area of the element of FIG. 1.

FIG. 7 shows a similar view to FIG. 6, with one of the frame members pivoted upwardly.

FIG. 8 shows an alternative embodiment of an element with different cable management at the entry points.

FIG. 9 shows three of the elements of FIG. 8 mounted in a block formation, with cable radius limiters at the entry point mounted in an alternative position.

FIG. 10 is a perspective view of the block of FIG. 9.

FIG. 11 is a view of the block of FIG. 9, with the tray of the middle element pulled forward for access to the fiber terminations.

FIG. 12 shows an enlarged portion of an entry point for one of the elements with a cable radius limiter in a first position.

FIG. 13 shows a similar view as in FIG. 12, with the cable radius limiter positioned in an alternate position.

FIG. 14 shows an exploded view of a cable mount.

FIG. 15 shows an element with a cable mount on one side, and a cable radius limiter on an opposite side.

FIG. 16 shows an alternative cable mount.

FIGS. 17-29 show various views of the elements shown in FIGS. 1-16 including additional details and cable routings shown for illustration purposes.

FIG. 30 shows an alternative embodiment of a block of two alternative elements.

FIG. 31 shows a tray pulled forward from the chassis of one of the elements of the block of FIG. 30.

FIG. 32 shows the tray extended forward as in the view of FIG. 31, with one of the frame members pivoted upwardly.

FIG. 33 is a view similar to the view of FIG. 32, with a second frame member pivoted upwardly.

FIG. 34 shows a block including two elements.

FIG. 35 shows an exploded view of the two elements of the block of FIG. 34.

FIG. 36 shows a single element.

FIG. 37 shows an exploded view of the element of FIG. 36.

FIG. 38 shows the element of FIG. 37, without the top cover.

FIG. 39 is a top view of the element of FIG. 38.

FIG. 40 is an alternative view of the element of FIG. 38, showing alternative devices at the cable entry points.

FIG. 41 is a top view of the element of FIG. 40.

FIG. 42 shows an alternative embodiment of an element in a top view with an alternative synchronized movement feature.

FIG. 43 is a perspective view of the element of FIG. 42.

FIGS. 44 and 45 show movement of the various components of the synchronized movement feature of FIGS. 42 and 43.

FIGS. 46 and 47 show an element with an alternative radius limiter at the cable entry and exit locations.

FIG. 48 shows a cross-sectional view of a portion of a universal mounting mechanism having features that are examples of inventive aspects of the disclosure, the universal mounting mechanism configured for mounting an optical fiber distribution element similar to those shown in FIGS. 30-47 of the present disclosure to a telecommunications rack, the mounting mechanism shown in a locked position.

FIG. 49 illustrates the universal mounting mechanism of FIG. 48 in an unlocked position.

FIG. 50 illustrates a partially exploded perspective view of a portion of the universal mounting mechanism of FIGS. 48-49 being used on an optical fiber distribution element similar to the elements shown in FIGS. 30-47.

FIG. 51 illustrates the universal mounting mechanism of FIG. 50 with the universal mounting brackets of the mechanism mounted to the element of FIG. 50.

FIG. 51A is a close-up view of a portion of the universal mounting mechanism of FIG. 51, illustrating the locking spring in a locked position with respect to the universal mounting bracket.

FIG. 52 is a cross-sectional view of a portion of the universal mounting mechanism of FIG. 48 showing the positional relationship between the universal mounting bracket and the release handle of the mounting mechanism when the mounting mechanism is in a locked state.

### DETAILED DESCRIPTION

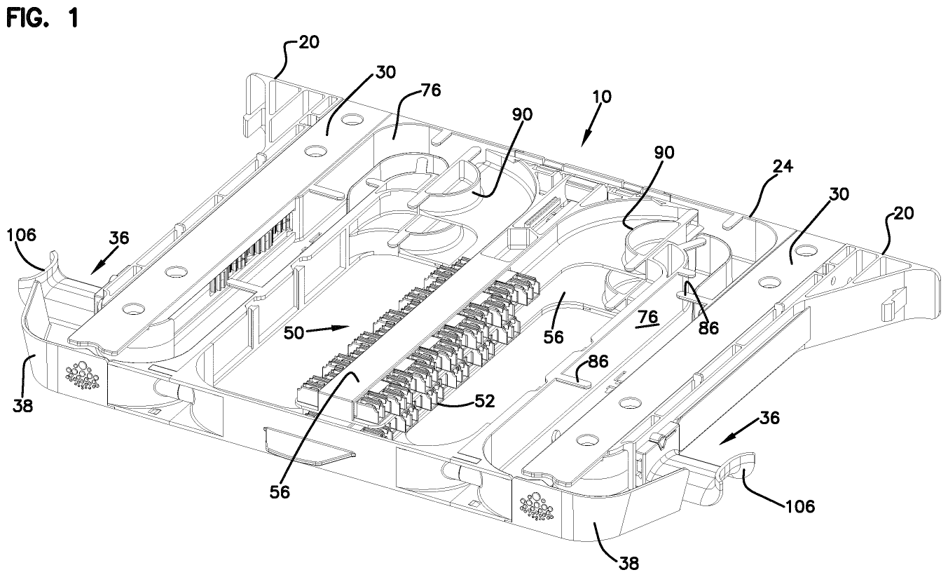

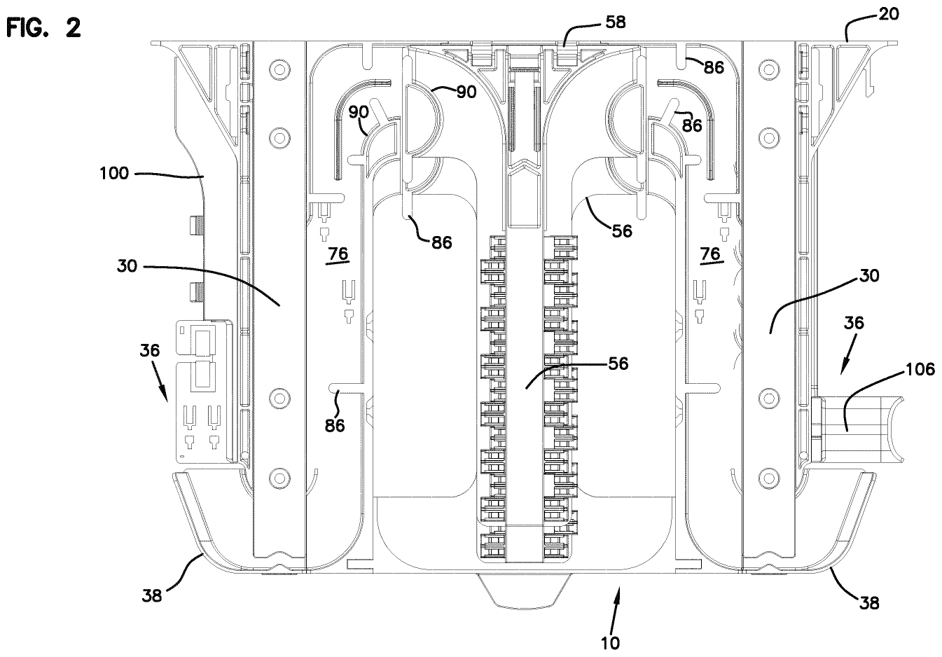

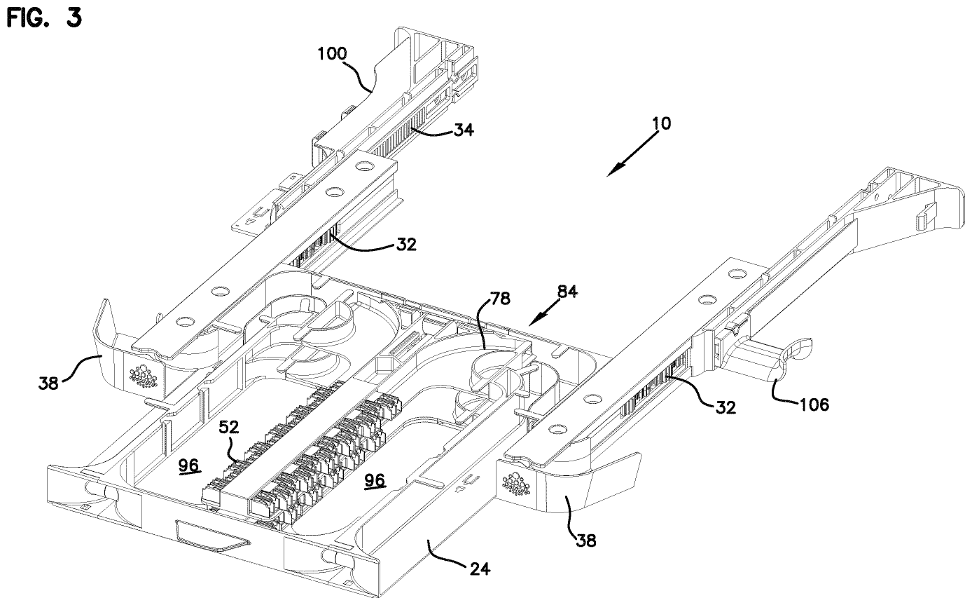

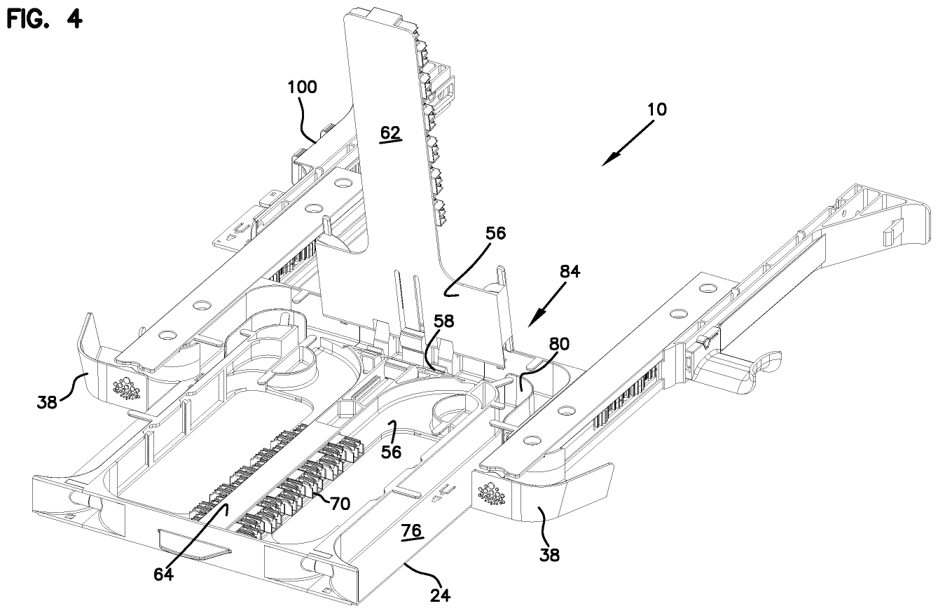

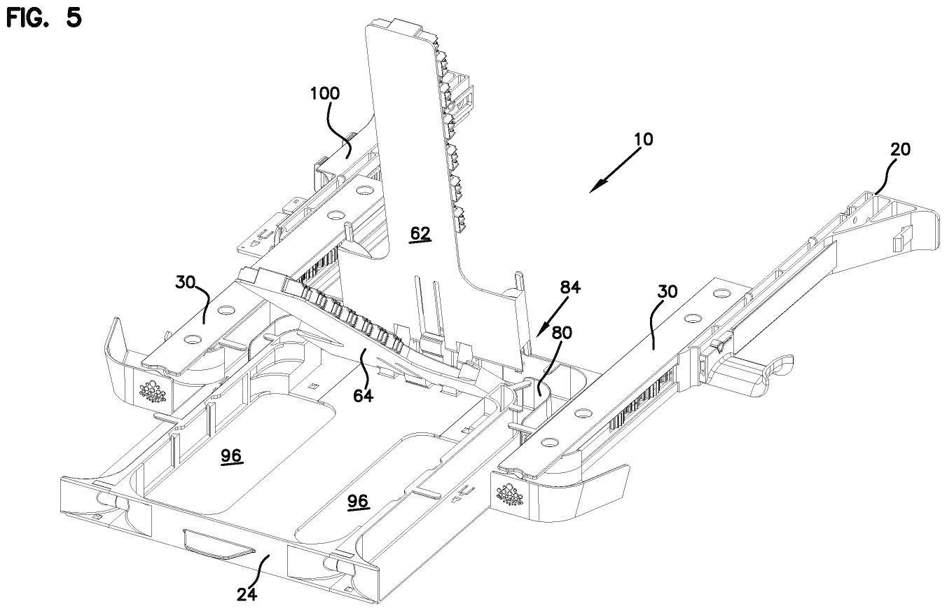

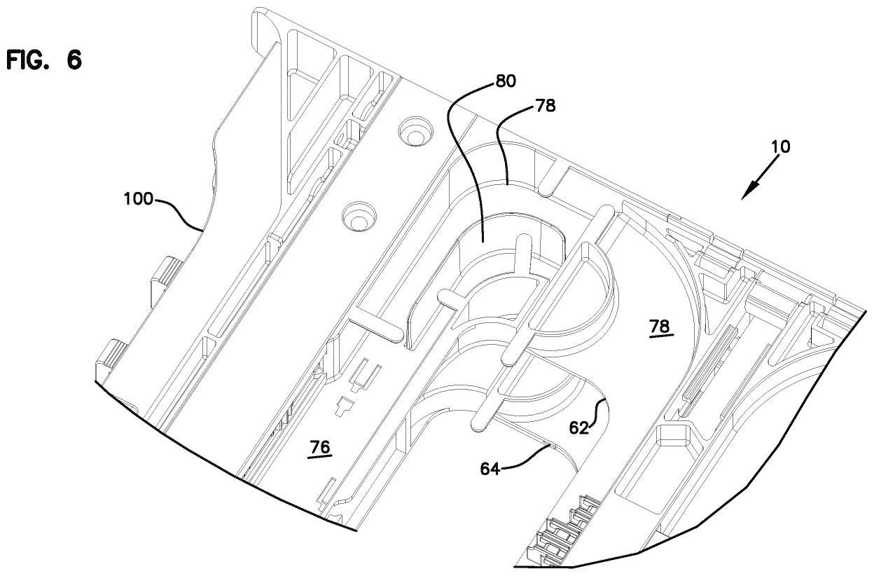

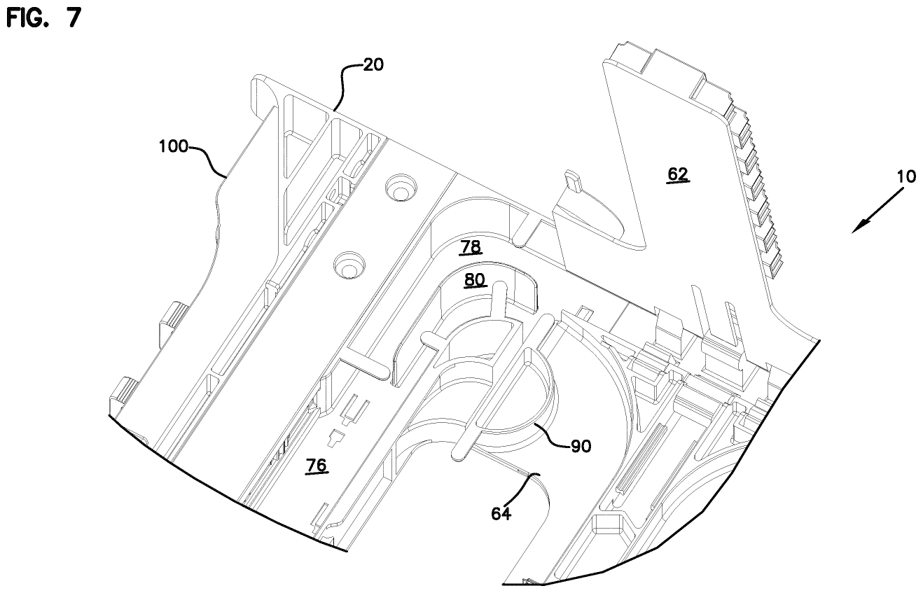

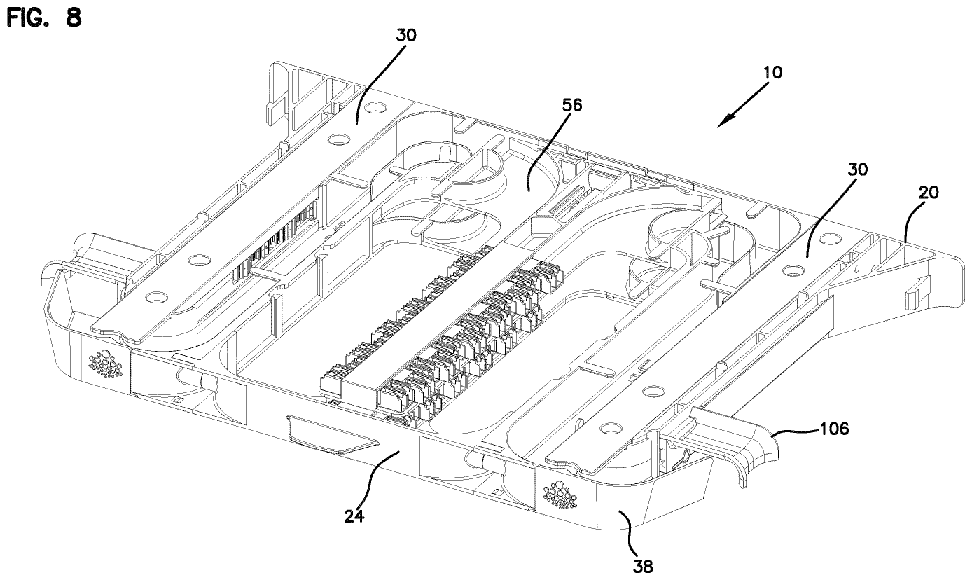

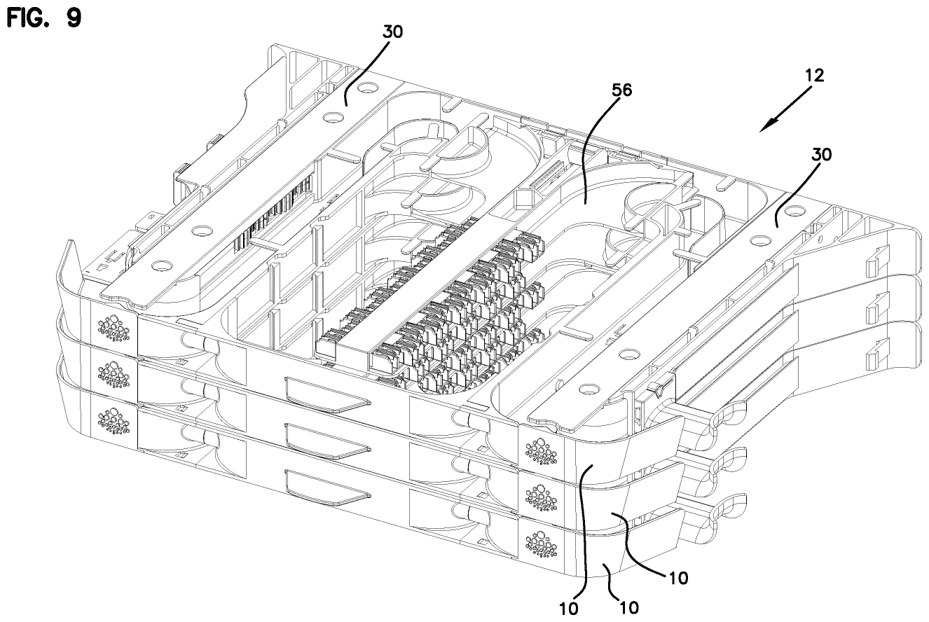

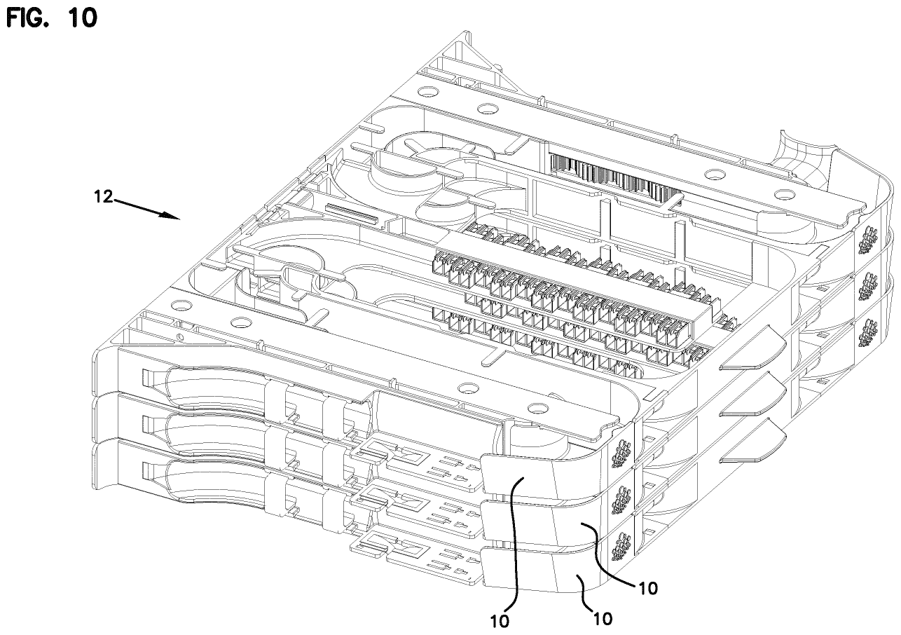

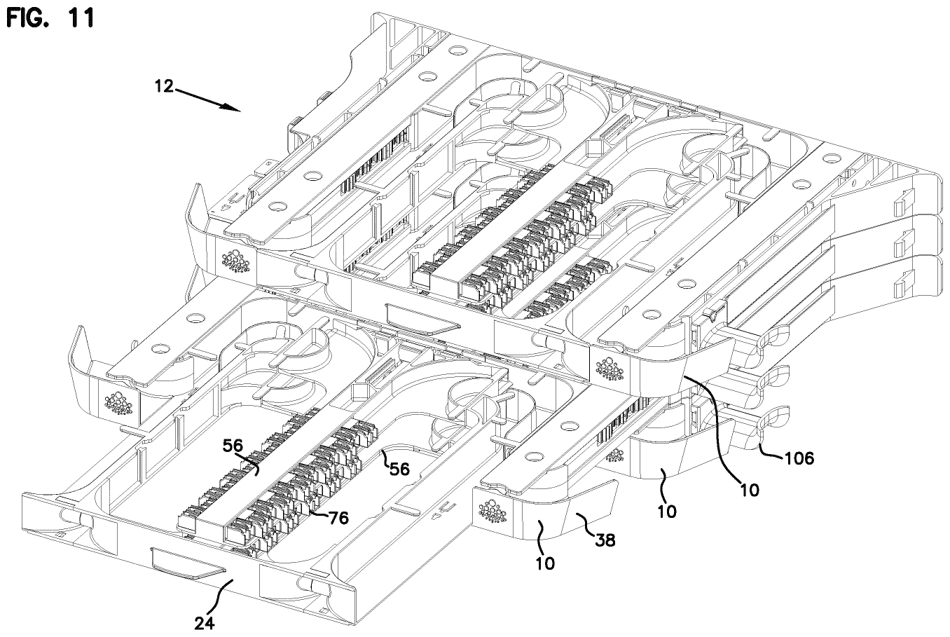

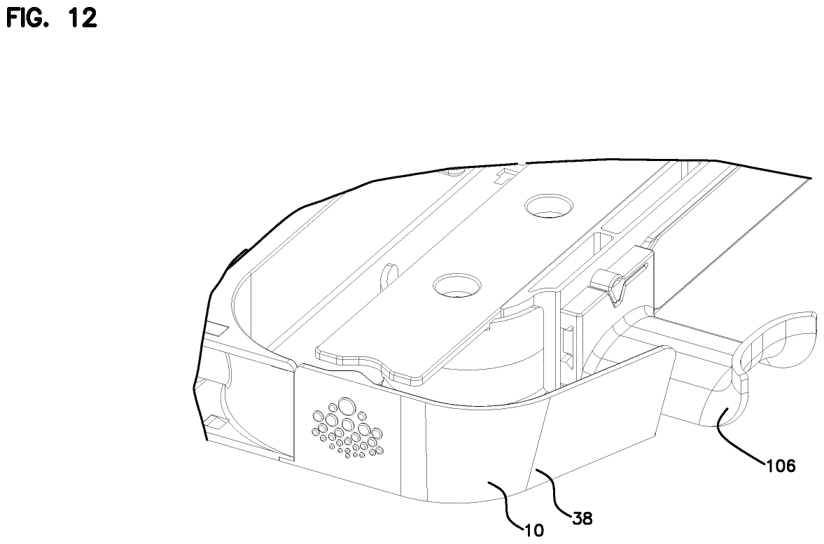

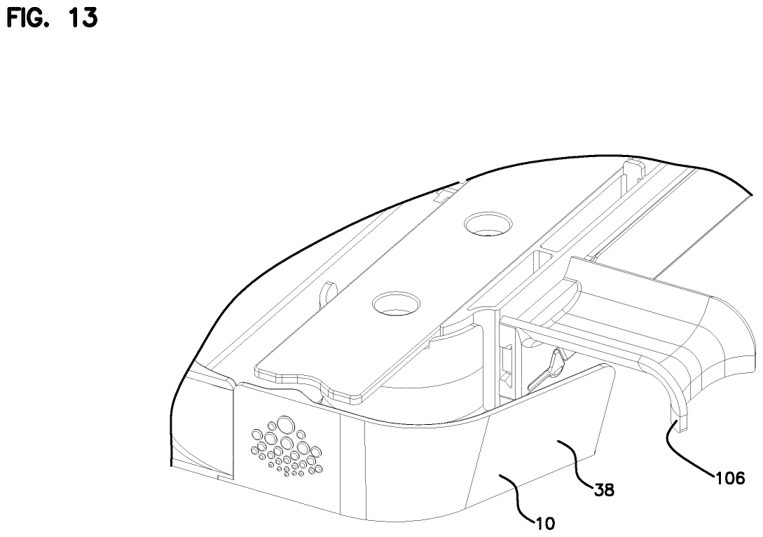

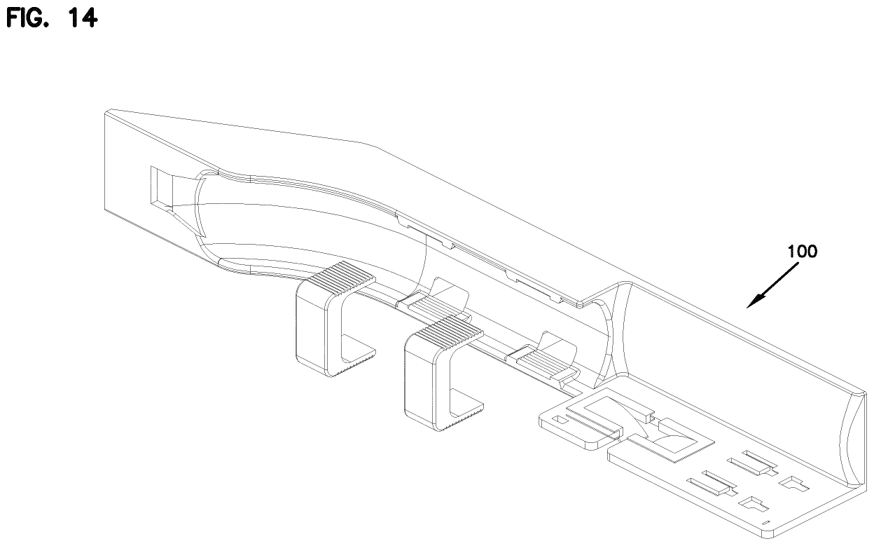

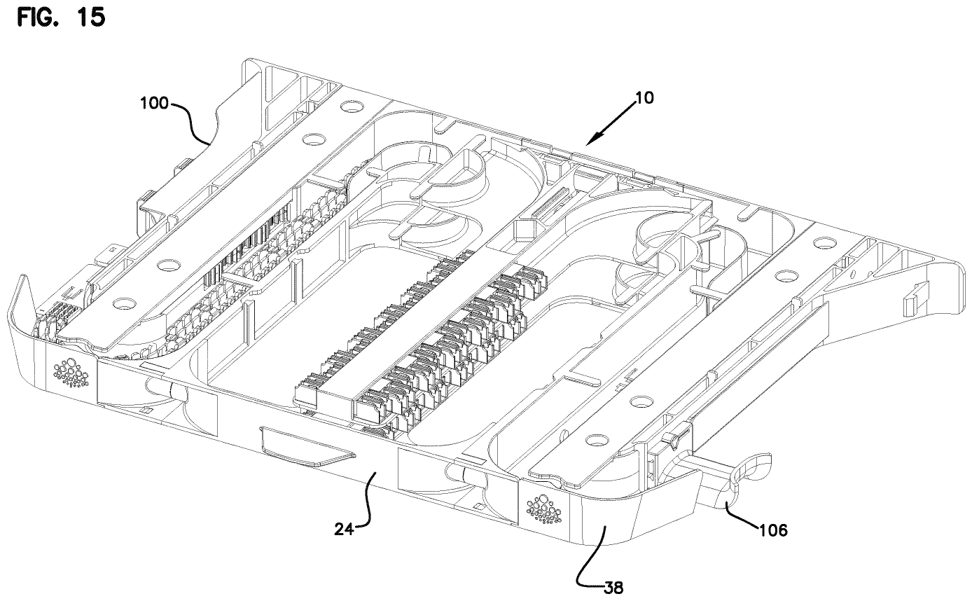

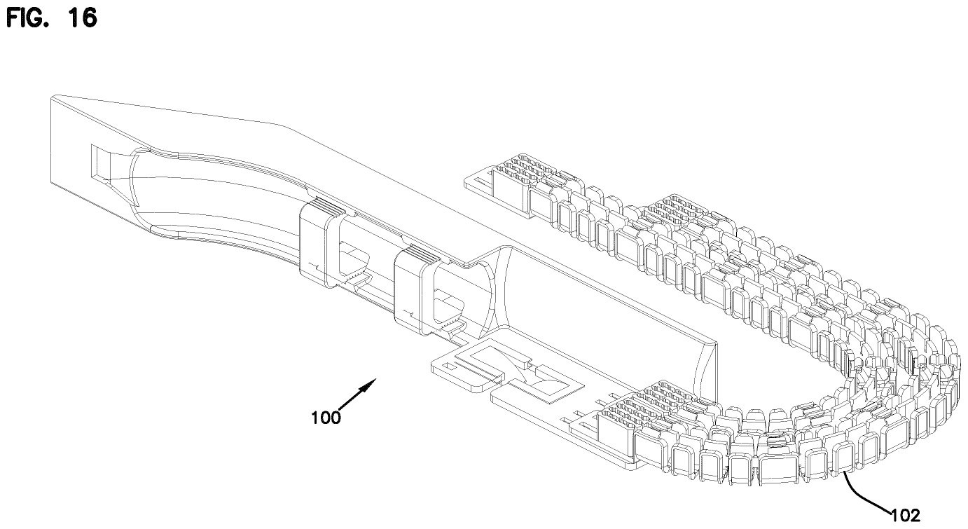

Referring now to FIGS. 1-16, various embodiments of an optical fiber distribution element 10, or element 10, are shown. The elements 10 can be individually mounted as desired to telecommunications equipment including racks, frames, or cabinets. The elements 10 can be mounted in groups or blocks 12 which form a stacked arrangement. In one embodiment, a vertical stack of elements 10 populates an optical fiber distribution rack.

Each element 10 holds fiber terminations, or other fiber components including fiber splitters and/or fiber splices. In the case of fiber terminations, incoming cables are connected to outgoing cables through connectorized cable ends which are connected by adapters, as will be described below.

Each element includes a chassis 20 and a movable tray 24. Tray 24 is movable with a slide mechanism 30 including one or more gears 32 and a set of two toothed racks or linear members 34.

Slide mechanism 30 provides for synchronized movement for managing the cables extending to and from tray 24. Entry points 36 on either side of chassis 20 allow for fixation of the input and output cables associated with each element 10. The radius limiters 38 associated with each slide mechanism 30 move in synchronized movement relative to chassis 20 and tray 24 to maintain fiber slack, without causing fibers to be bent, pinched, or pulled.

Each tray 24 includes mounting structure 50 defining one or more fiber terminations, fiber splitters, fiber splices, or other fiber components. As shown, mounting structure 50 holds adapters 52 which allow for interconnection of two connectorized ends of cables. Each tray 24 includes one or more frame members 56. In the example shown, two frame members 56 are provided. As illustrated, each frame member 56 is T-shaped. Also, each tray 24 includes two frame members 56 which are hingedly mounted at hinges 58. A top frame member 62 is positioned above a bottom frame member 64. The mounting structure 50 associated with each frame member 62, 64 includes one or more integrally formed adapter blocks 70. Adapter blocks 70 include a plurality of adapter ports for interconnecting to fiber optic connectors. A pathway 76 defines a generally S-shape from radius limiters 38 to adapter blocks 70. As shown, pathway 76 includes an upper level 78 and a lower level 80 in the interior. A portion 84 of pathway 76 is positioned adjacent to hinges 58 to avoid potentially damaging cable pull during pivoting movement of frame members 56. Flanges 86 and radius limiters 90 help maintain cables in pathways 76.

Tray 24 includes openings 96 to allow for technician access to the cable terminations at adapter blocks 70. In addition, the T-shapes of frame members 56 further facilitate technician access to the connectors.

Cables extending to and from element 10 can be affixed with a cable mount 100 as desired. Additional protection of the fiber breakouts can be handled with cable wraps 102. Radius limiters 106 can be additionally used to support and protect the cables.

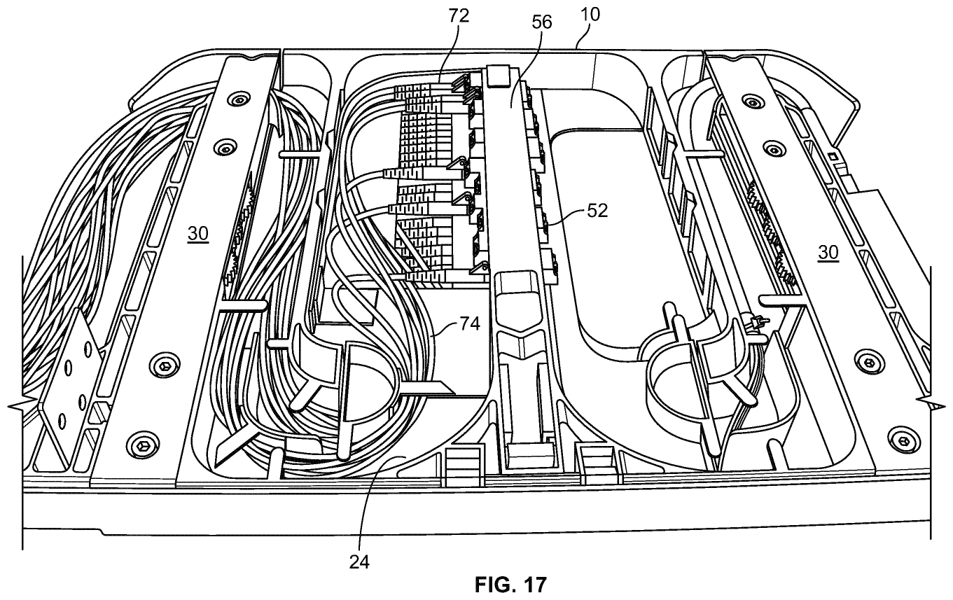

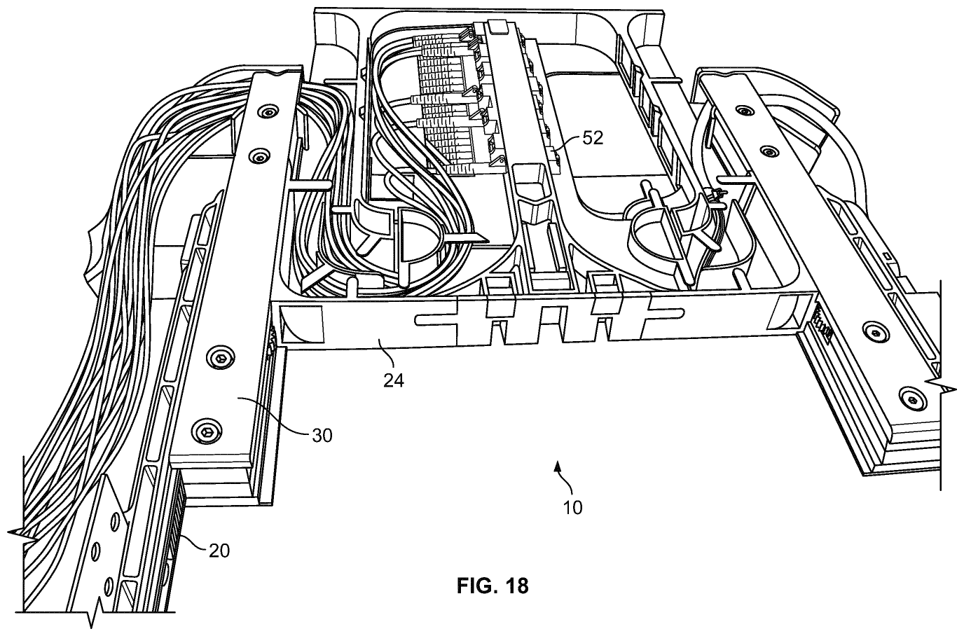

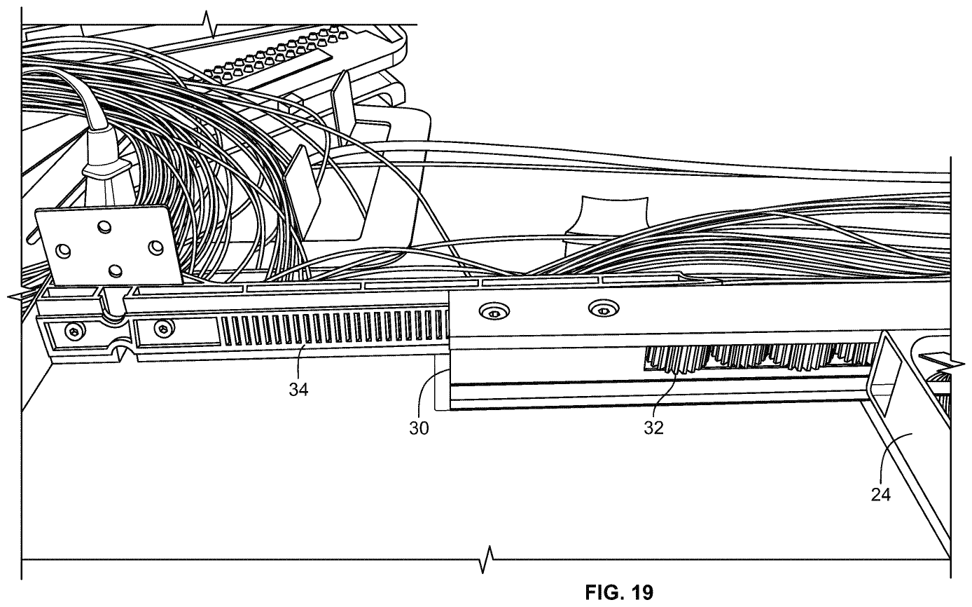

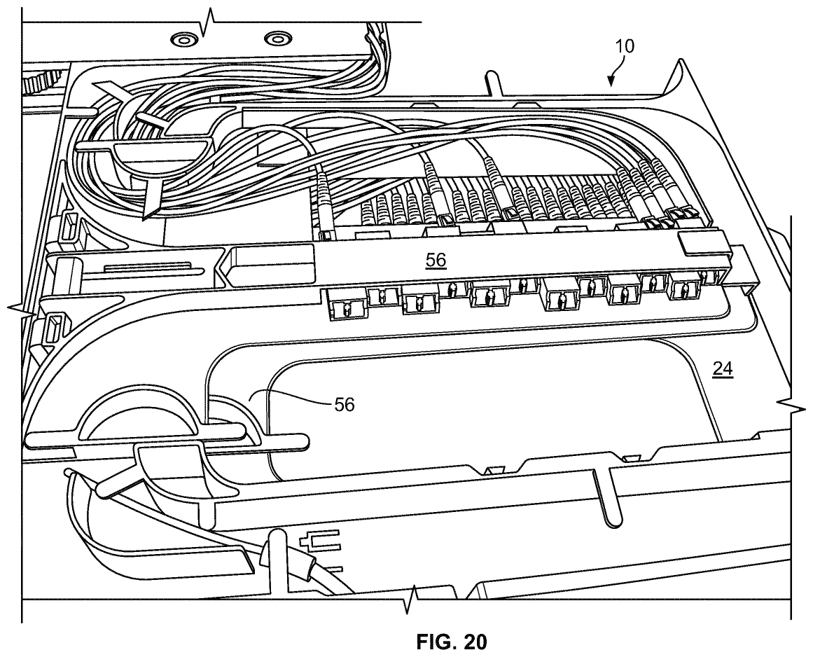

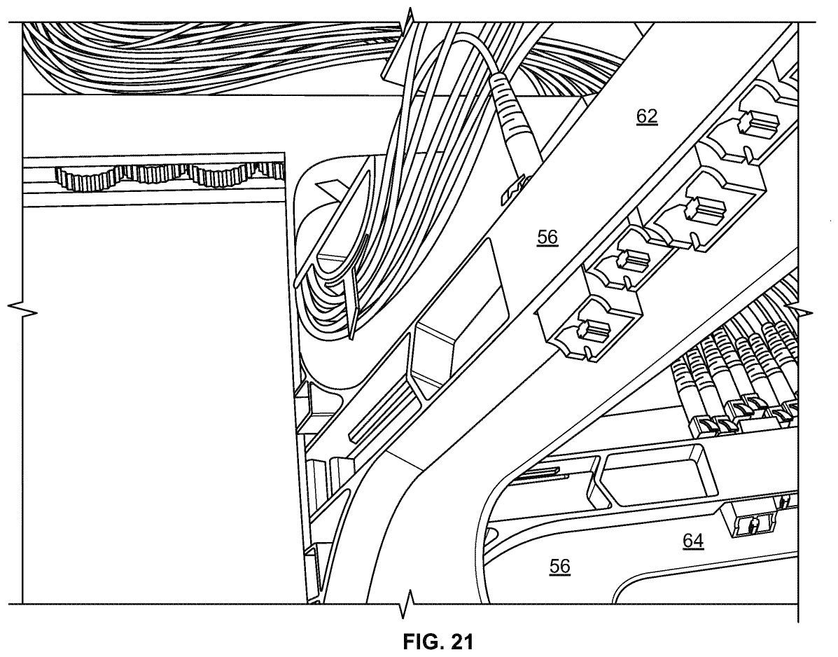

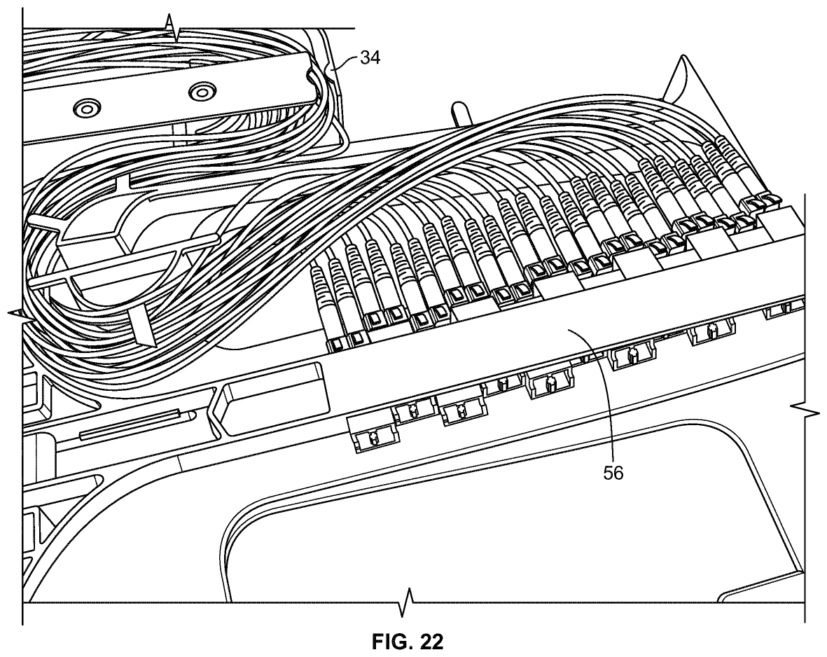

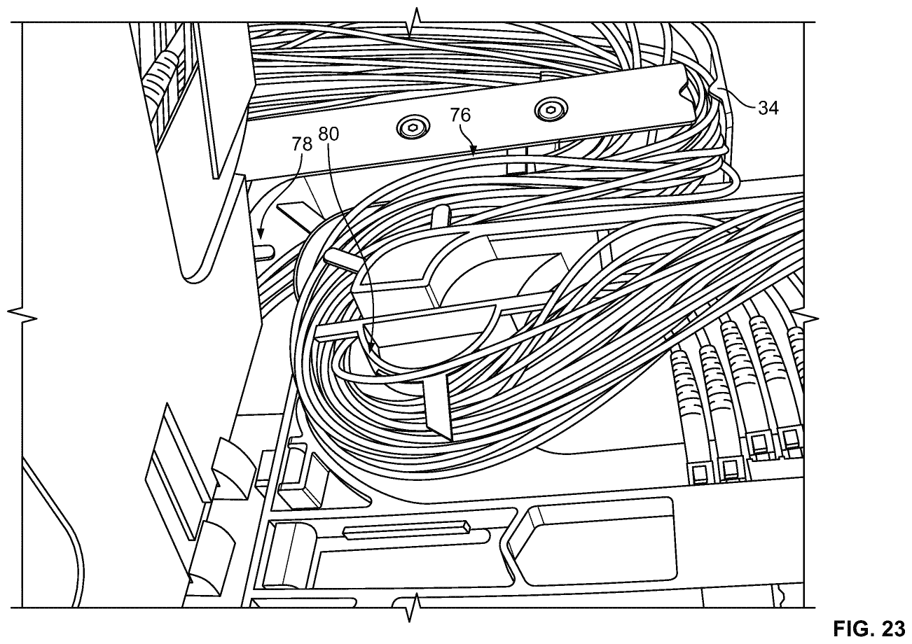

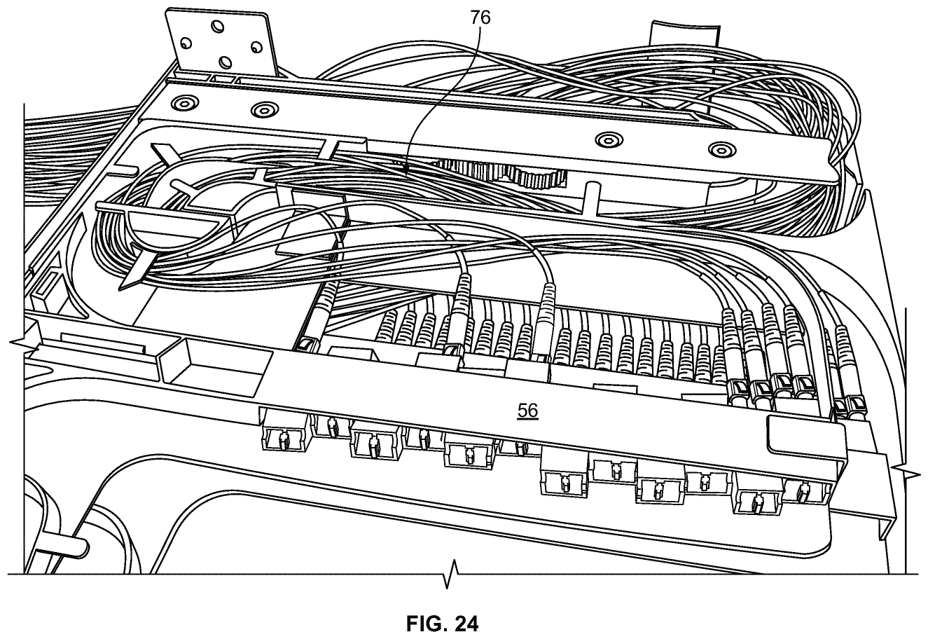

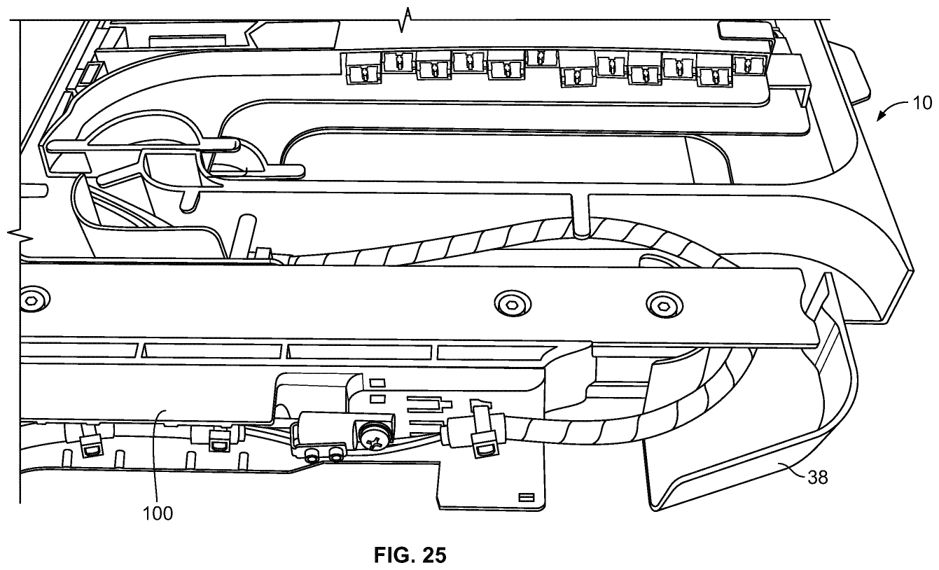

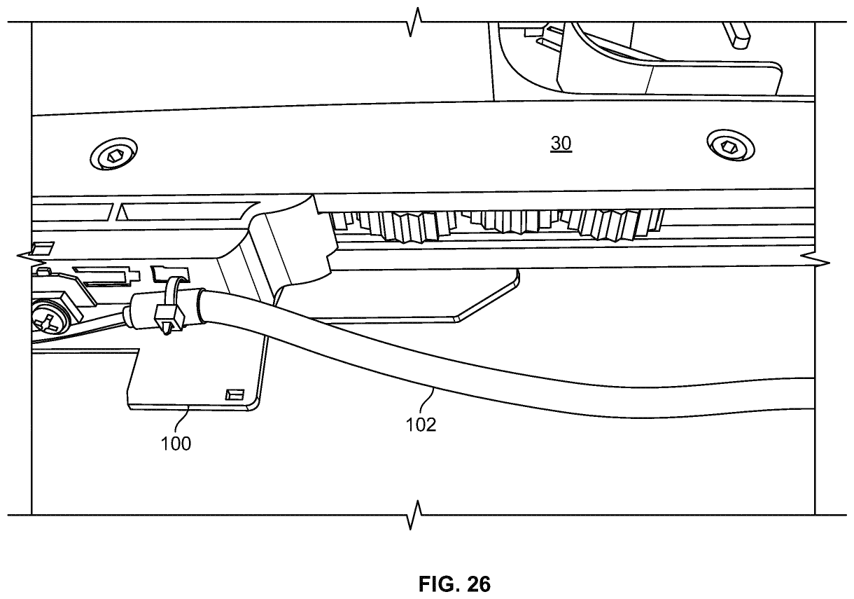

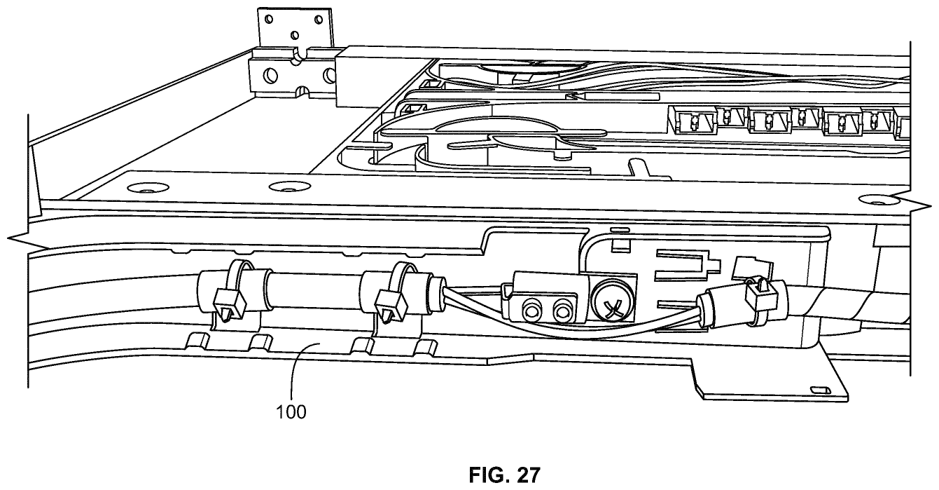

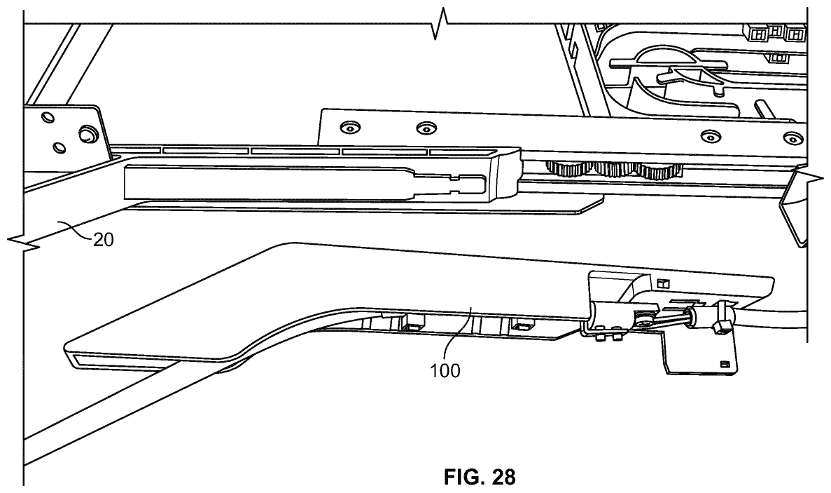

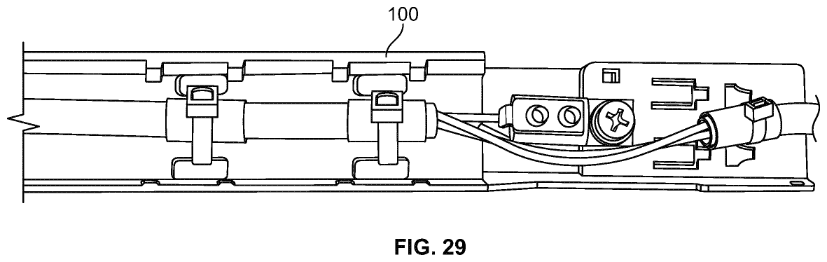

Referring now to FIGS. 17-29, various examples of cable routings are illustrated for element 10.

If desired, more than one feeder cable can supply cabling to more than one element 10.

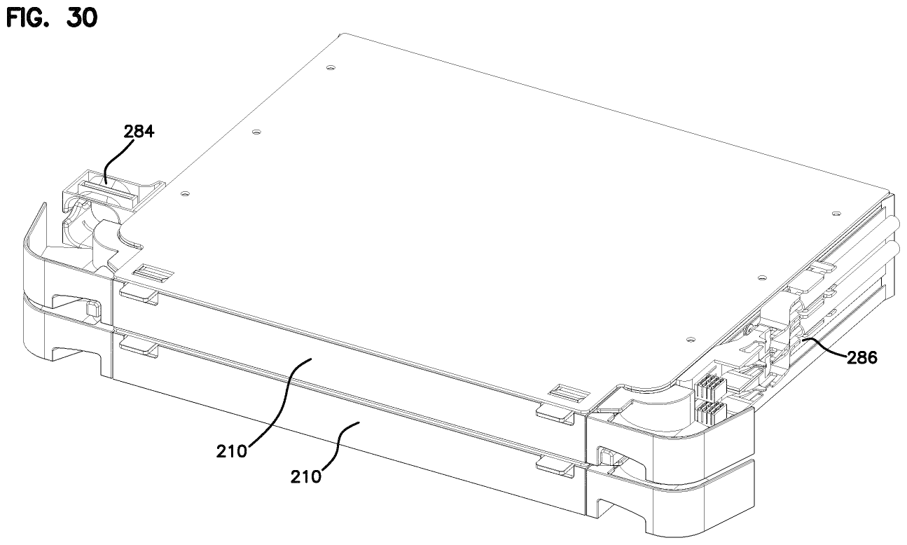

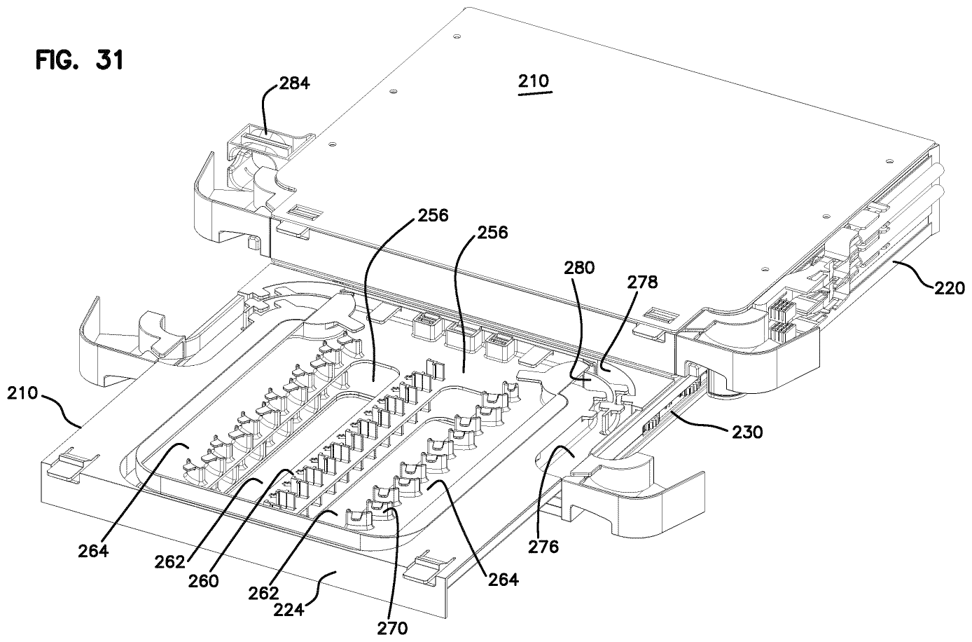

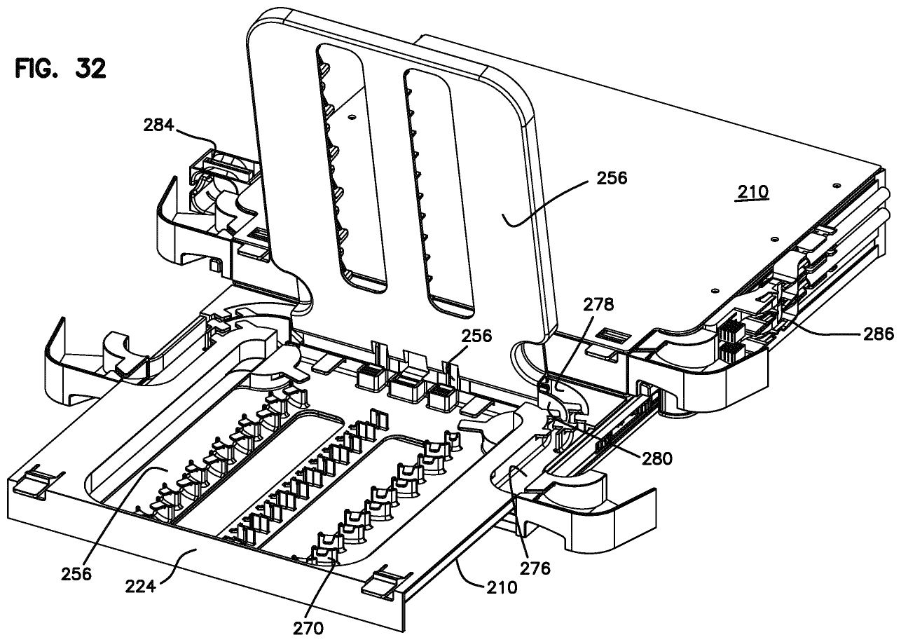

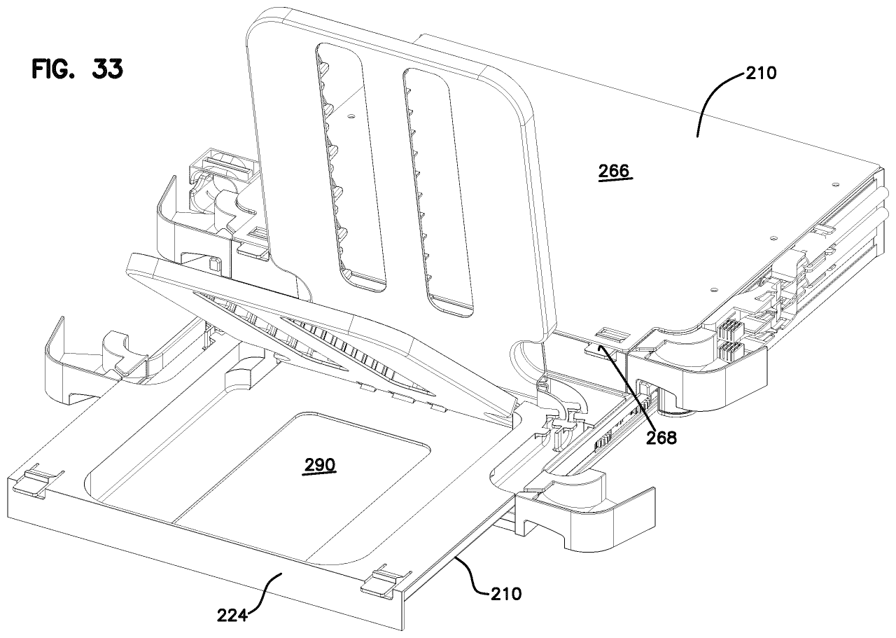

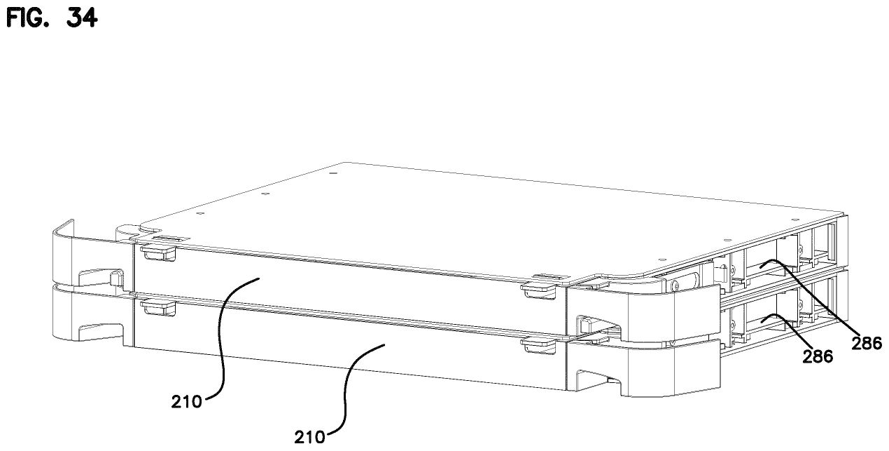

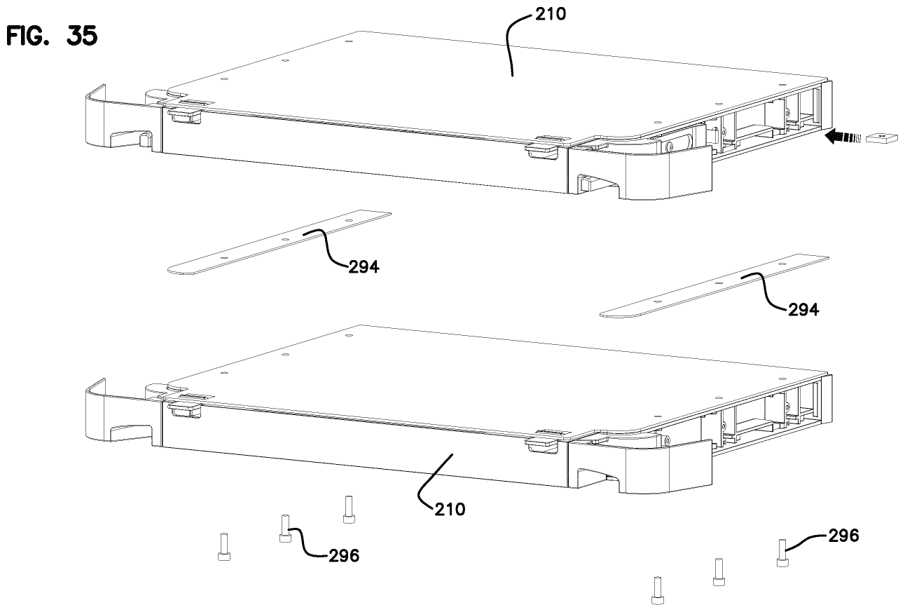

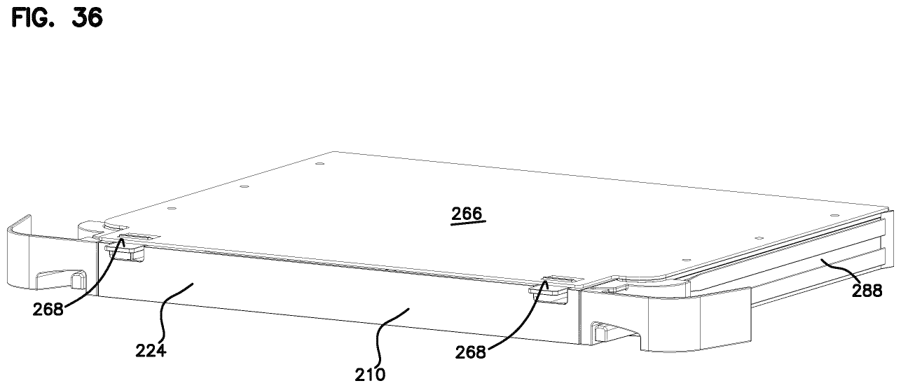

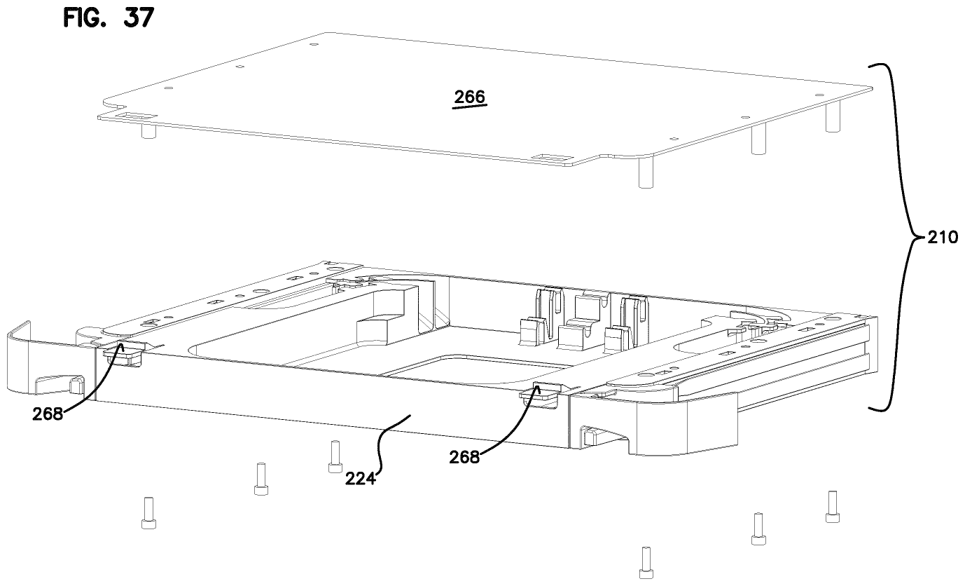

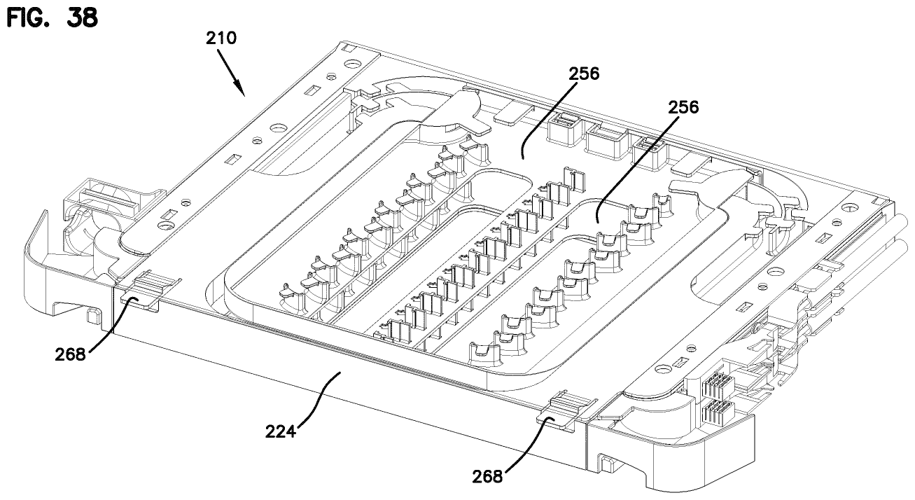

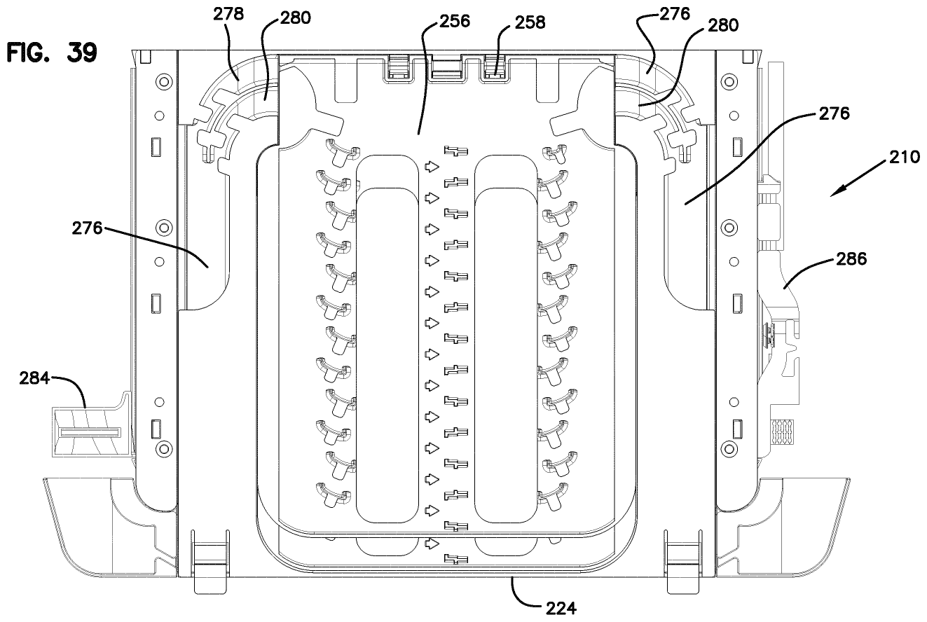

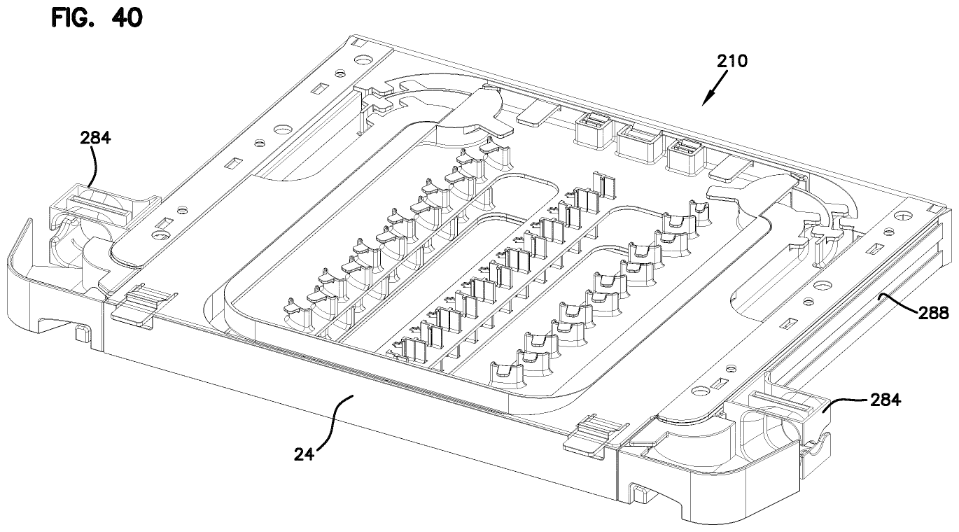

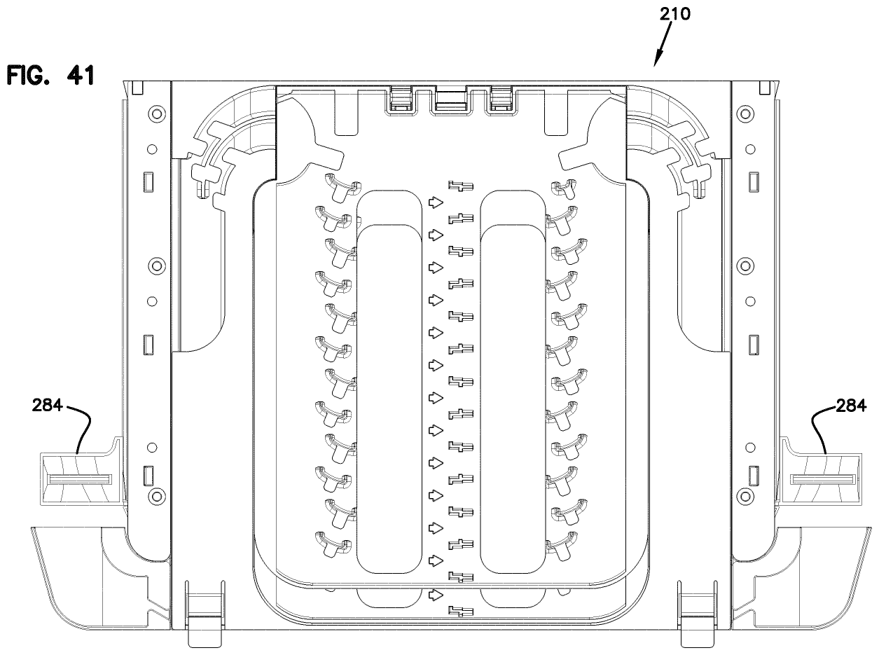

Referring now to FIGS. 30-41, various additional embodiments of elements 210 are shown. Element 210 includes a chassis 220 in a movable tray 224 mounted with a slide mechanism 230 which promotes synchronized movement of radius limiters 238. Each tray 224 includes two hingedly mounted frame members 256. Each frame member 256 has a middle portion 260 separated by openings 262 from side portions 264. Middle portion 260 can hold fiber terminations. Side portions 264 include radius limiters 270. Cover 266 goes over tray 224. Latches 268 latch tray 224 to cover 266 in the closed position.

A pathway 276 extends from either side of tray 224 to supply cables to each of trays 224. An upper level 278 and a lower level 280 supply the respective frame members 256 with cabling. A general S-shaped pathway 276 is defined wherein the pathway 276 passes close to hinges 258.

A dovetail 288 is used to hold cable mounts 286 and radius limiters 284.

An opening 290 in tray 224 allows for connector access by the technician. Similarly, openings 262 on each frame member 256 allow for technician access to the individual connectors.

To form a block 292 of plural elements 210, bars 294 and fasteners 296 are used. Bars 294 give a small spacing between each element 210.

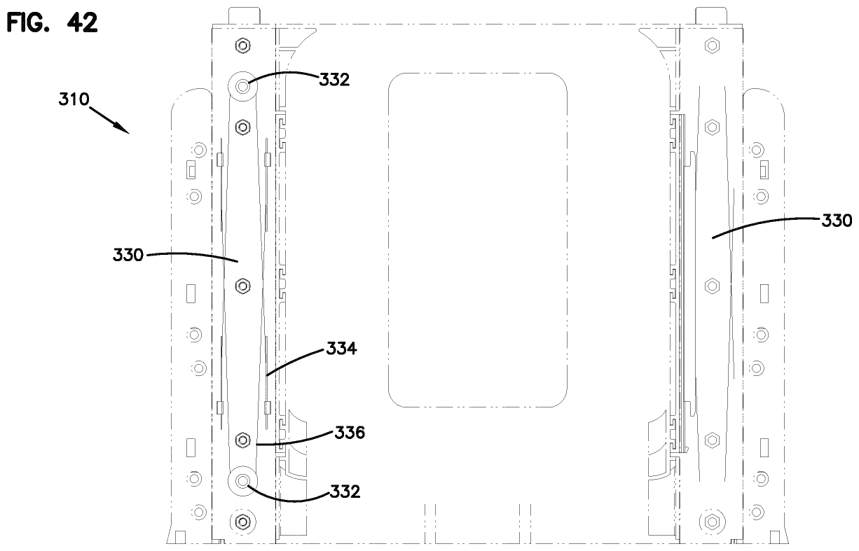

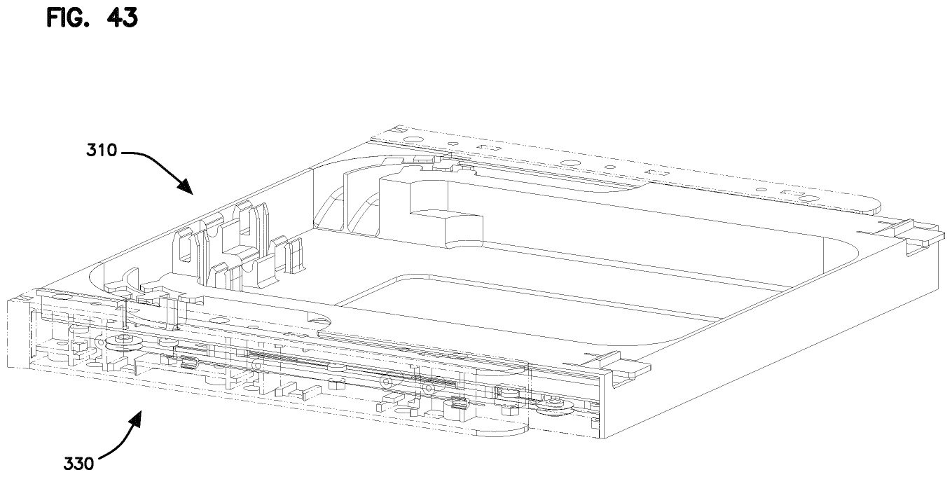

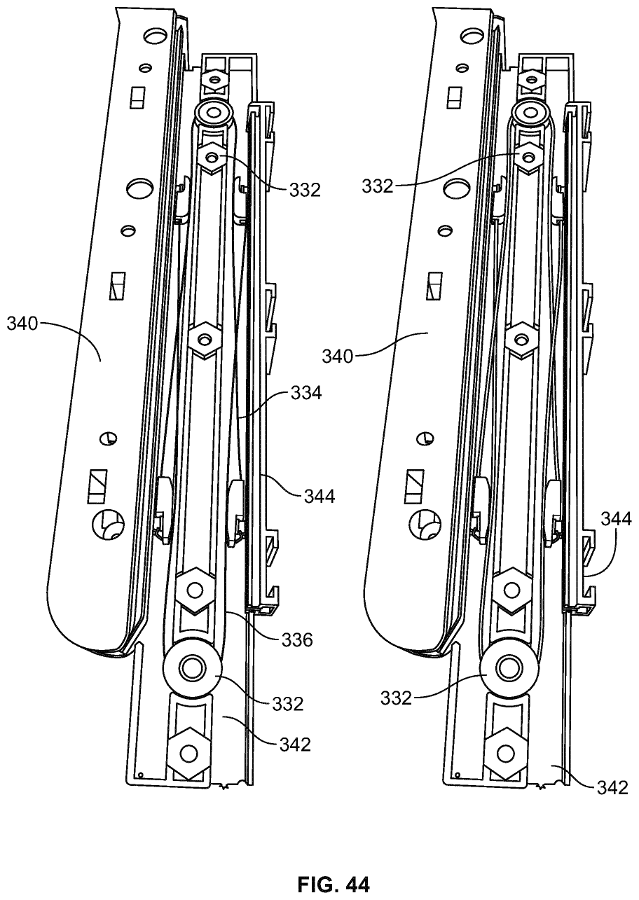

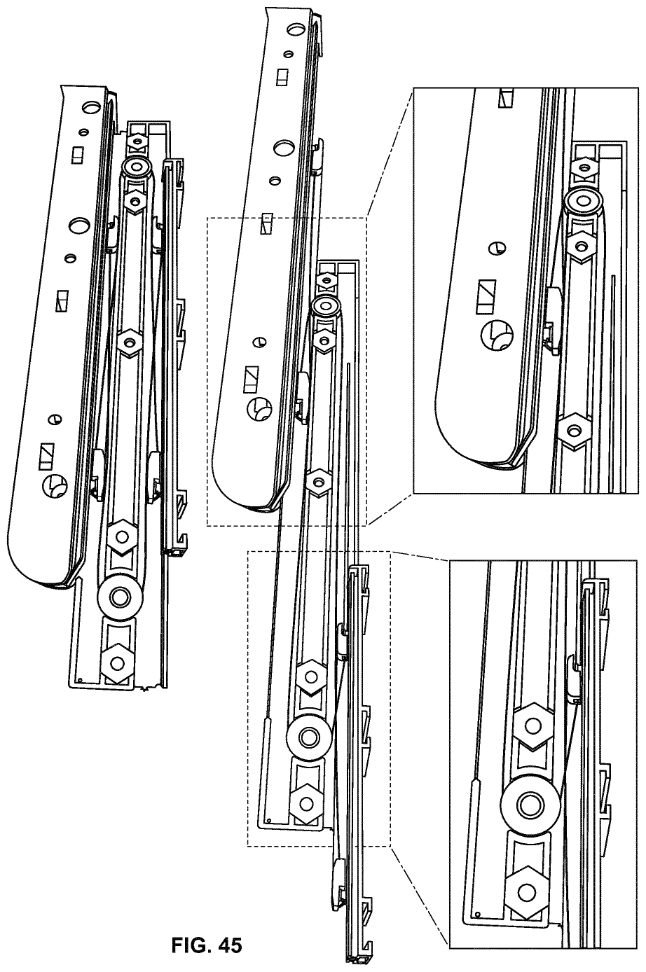

Referring now to FIGS. 42-45, an alternative slide mechanism 330 is shown in alternative element 310. Slide mechanism 330 allows for movement of the trays and related radius limiters and synchronized movement similar to slide mechanism 30, 230. Alternative slide mechanism 330 includes two wheels 332 and two wires 334, 336. The wheels 332 are located on second part 342. The wires are looped in opposite directions and are connected to the first part 340 and the third part 344.

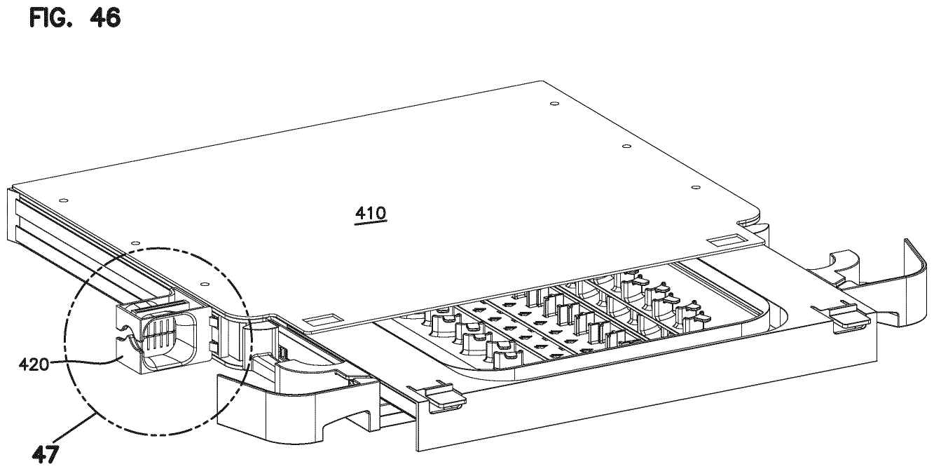

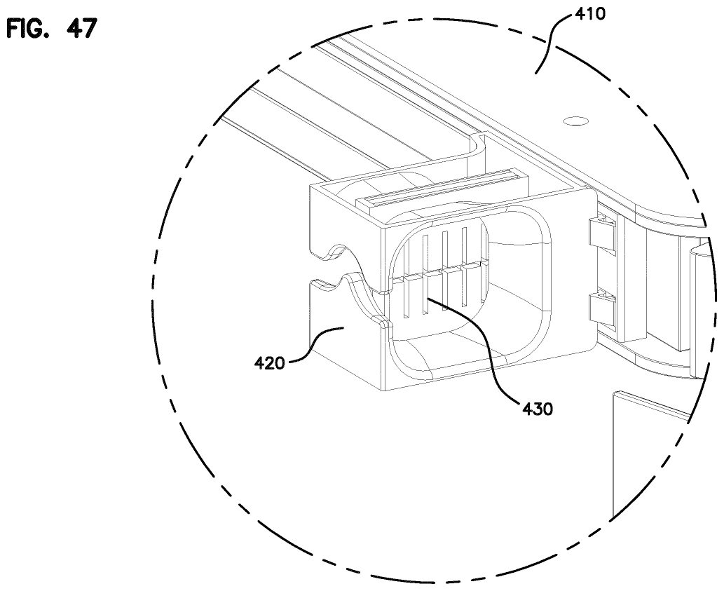

Referring now to FIGS. 46 and 47, an alternative radius limiter 420 is shown on alternative element 410. Radius limiter 420 includes friction members 430 which limit the amount of sliding movement of cables passing through radius limiter 420, to assist with cable management. Friction members 430 include flexible fingers which press lightly on the cables in radius limiter 420 to reduce or eliminate sliding movement of the cables in the radius limiter 420.

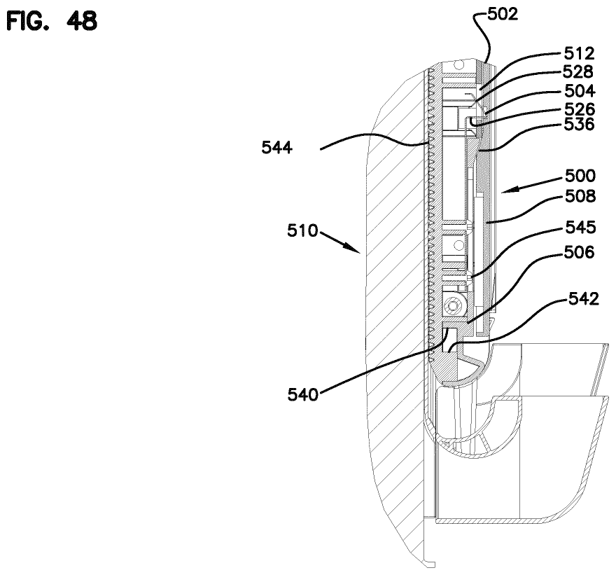

Referring now to FIGS. 48-52, a universal mounting mechanism 500 for releasably mounting a telecommunications chassis to a telecommunications fixture, such as an optical fiber distribution rack, is illustrated. In FIGS. 48-52, the universal mounting mechanism 500 is shown as having been adapted for and being used on an optical fiber distribution element 510 having features similar to those elements 210, 410 shown in FIGS. 30-47 of the present disclosure. With the universal mounting mechanism 500 of FIGS. 48-52, telecommunications chassis or elements such as elements 210, 410, and 510 can be mounted as desired to telecommunications fixtures or equipment such as racks, frames, or cabinets.

It should be noted that although the universal mounting mechanism 500 of the present disclosure has been shown as being used on a piece of telecommunications equipment such as the optical fiber distribution element 510 (which has similar features to those elements 210 and 410 of FIGS. 30-47), the optical fiber distribution element 510 is simply one example of telecommunications equipment or chassis on which the mounting mechanism 500 may be used for mounting to equipment such as telecommunications racks, frames, or cabinets. For use with the universal mounting mechanism 500 of FIGS. 48-52, the element 510 has been adapted to receive certain portions of the mounting mechanism 500. However, it should be understood that the mounting mechanism 500 of the present disclosure includes features having inventive aspects in isolation and can be used on other types of optical fiber distribution elements as long as the elements or chassis thereof are adapted to receive portions of the mounting mechanism 500.

Still referring to FIGS. 48-52, the universal mounting mechanism 500 will now be described in further detail.

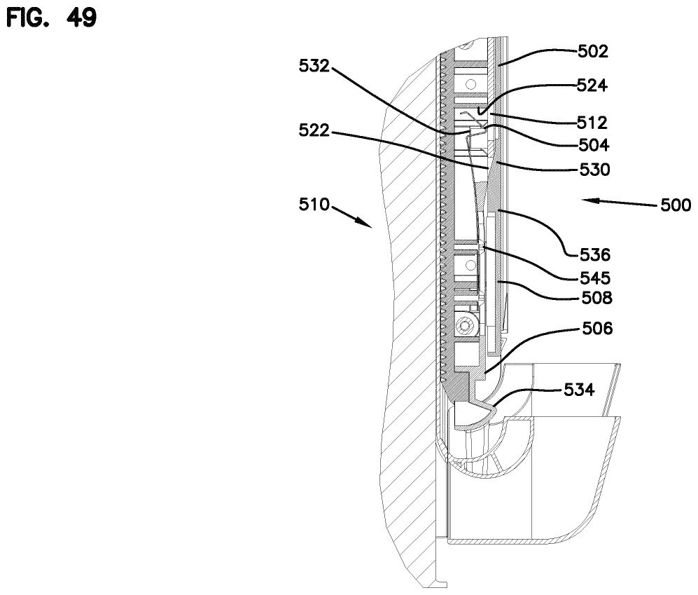

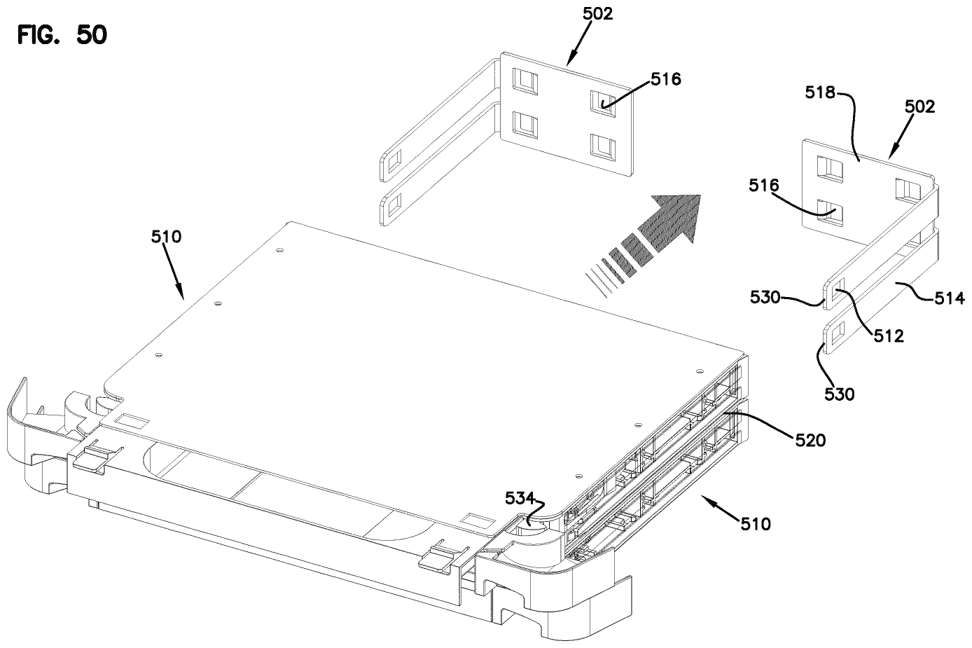

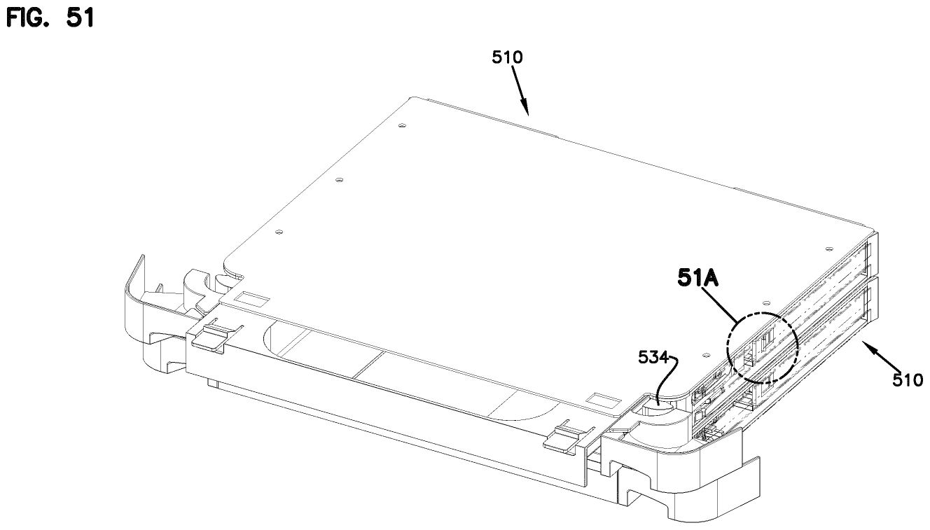

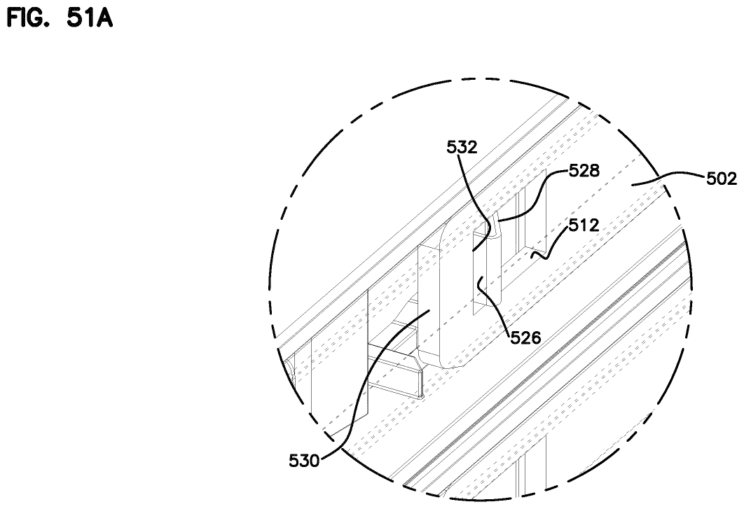

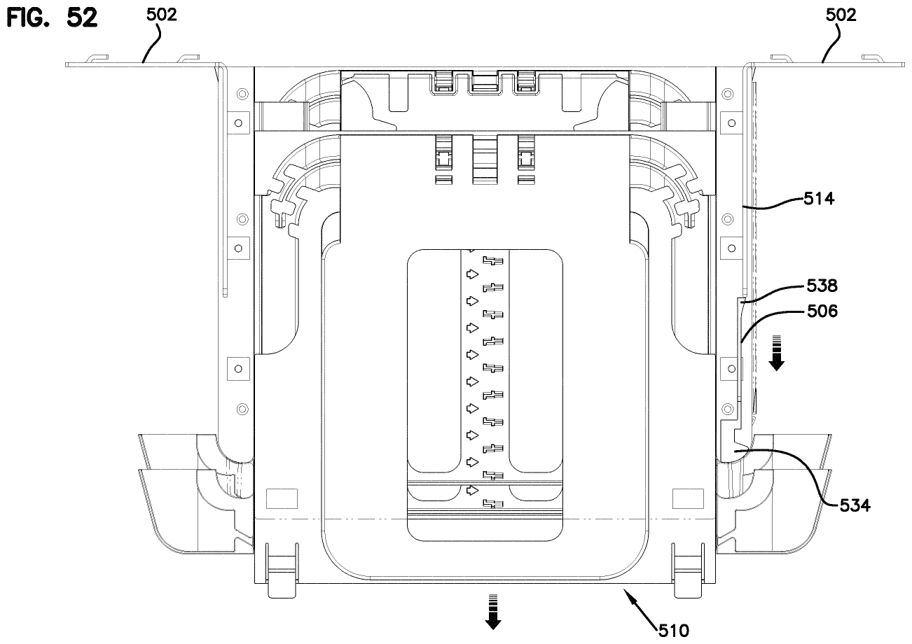

FIG. 48 shows a cross-sectional view of a portion of the universal mounting mechanism 500, wherein the mounting mechanism 500 is in a locked state or position. FIG. 49 illustrates the universal mounting mechanism 500 in an unlocked position. FIG. 50 illustrates a partially exploded perspective view of a portion of the universal mounting mechanism 500 being used with the optical fiber distribution element 510, which is similar to the elements 210, 410 shown in FIGS. 30-47, as noted above. FIG. 51 illustrates the universal mounting mechanism 500 with the universal mounting brackets 502 of the mechanism 500 mounted to the element 510. FIG. 51A is a close-up view of a portion of the universal mounting mechanism 500, illustrating a locking spring 504 of the mechanism 500 in a locked position with respect to the universal mounting bracket 502 of the mechanism 500. FIG. 52 is a cross-sectional view of a portion of the universal mounting mechanism 500 showing the positional relationship between the universal mounting bracket 502 and a release handle 506 of the mounting mechanism 500 when the mechanism 500 is in a locked state.

The universal mounting mechanism 500 generally includes the right and left universal mounting brackets 502, release handles 506 for each of the mounting brackets 502, a cover 508 for each of the mounting brackets 502, and the locking spring 504 for each of the mounting brackets 502.

In the depicted embodiment, each of the universal mounting brackets 502 is designed for mounting two stacked elements 510. Thus, each of the right and left mounting brackets 502 includes two latch openings 512 adjacent the front 514 of the mounting bracket 502 (one for each element 510) and upper and lower mounting tabs 516 at the rear 518 of the bracket 502.

In the given embodiment, the mounting tabs 516 at the rear 518 of the mounting brackets 502 are designed to slidably mount the brackets 502 to fixtures such as telecommunications racks along a sideway or lateral direction. As such, in mounting elements 510 to a rack, the universal mounting brackets 502 are initially slid into openings provided on the rack using the mounting tabs 516. Once the brackets 502 are secured on a rack, the elements 510 can be slid onto the brackets 502 in a sliding fashion, as will be described in further detail. The latch openings 512 of the brackets 502 are then used to lock the elements 510 in place.

In using the universal mounting mechanism 500 of the present disclosure, each element 510, on each of the right and left sides thereof, defines a bracket channel 520. The channel 520 is configured to slidably receive the front portions 514 of the mounting brackets 502. The cover 508 closes the bracket channel 520 to the exterior of each element 510. The cover 508 defines a deflection ramp 522 at the inner face thereof, the purpose of which will be discussed in further detail below. The locking spring 504 is mounted to each element 510 such that an end portion 524 of the locking spring 504 can flex in and out of the latch opening 512 of the universal mounting bracket 502. As shown in the cross-sectional views of FIGS. 48 and 49 and in FIGS. 51 and 51A, the end portion 524 of the locking spring 504 defines a perpendicular locking face 526 and an angular insertion face 528. When an element 510 is initially being slidably mounted on the mounting bracket 502, the angled insertion face 528 rides over the front end 530 of the front portion 514 of the mounting bracket 502 until the end portion 524 of the locking spring 504 flexibly snaps into the latch opening 512.

The element 510, at this point, is prevented from being pulled out forwardly. The locking spring 504 abuts an inner front face 532 defined by the latch opening 512 of the mounting bracket 502 to prevent removal of the chassis from a rack.

The release handle 506 is positioned between the locking spring 504 and the cover 508. The release handle 506 has a grip portion 534 for pulling the release handle 504 forwardly to release the chassis for removal from the mounting brackets 502. The release handle 504 also defines a deflection tab 536 at the rear end 538. The deflection tab 536 is configured to ride over the deflection ramp 522 of the cover 508 when the grip portion 534 is pulled forwardly. The interaction of the deflection tab 536 and the deflection ramp 522 causes lateral inward movement of the deflection tab 536, which in turn, pushes the spring 504 laterally inwardly, clearing the end portion 524 of the locking spring 504 from the latching opening 512. In this manner, when the release handle 506 is pulled forwardly, the interaction of the deflection tab 536 and the deflection ramp 522 causes the release of the spring 504, and thus the entire element 510, from the mounting bracket 502. The chassis and the entire element 510 can be pulled forwardly from the mounting bracket 502.

In using the universal mounting mechanism 500 on the element 510, a tray of the element 510 has to be pulled from its chassis to allow enough room for gripping the release handle 506 as seen in FIG. 52, to pull it forwardly. In initially mounting the element 510 to a rack using the universal mounting mechanism 500, the release handle 506 has to be either pushed rearwardly by the user to allow the spring 504 to be positioned in its locking position or the user can simply push a tray of the element 510 rearwardly to contact the grip portion 534 of the release handle 506 to push the release handle 506 rearwardly. Thus, when the element 510 is mounted to a rack using the universal mounting mechanism 500, the release handle 506 must be in its rearward position to allow the spring 504 to be in its locking position. Otherwise, if the release handle 506 is in its forward position, the element 510 can simply slide out of the brackets 502.

The release handle 506 defines a positive stop 540 that is configured to abut a stop face 542 defined by a portion of a slide mechanism 544 within the element 510. The abutment of the stop 540 with the stop face 542 prevents further forward pulling of the release handle 506.

The universal mounting mechanism 500 includes a design that may be retrofitted on a number of telecommunications chassis. As long as a bracket channel 520 is provided in the chassis and the chassis includes enough spacing on the sides thereof for receiving a locking spring 504, a release handle 506, and a cover 508 for interacting with the release handle 506 and closing the mounting mechanism 500 to the exterior of the chassis, the universal mounting mechanism 500 can be utilized on a given chassis.

Also, as noted above, the rear portion 518 of the mounting brackets 502 may be modified to fit different types of mounting configurations on different types of telecommunications racks, frames, or cabinets. The mounting arrangement of the brackets 502 of the present disclosure that utilizes the tabs 516 for lateral slide-locking is simply one example of a mounting arrangement. Also, even though the mounting mechanism 500 of the present disclosure has been shown with mounting brackets 502 that can accommodate two vertically stacked elements 510, the mounting brackets 502 can be modified to receive other number of chassis, including a single chassis per bracket 502.

In the given embodiment, the locking spring 504 is fixed to the chassis with fasteners 545, allowing the end portion 524 of the locking spring 504 to be flexible. Other fixing methods may be used for the locking spring 504 in other types of telecommunications equipment.

### PARTS LIST

10 element
12 block
20 chassis
24 tray
30 slide mechanism
32 gears
34 rack
36 entry points
38 radius limiters
50 mounting structure
52 adapters
56 T-shaped frame member
58 hinge
62 top frame member
64 bottom frame member
70 adapter blocks
72 connectors
74 cables
76 pathway
78 upper level
80 lower level
84 portion
86 flanges
90 radius limiters
96 openings
100 cable mount
102 cable wrap
106 radius limiters
210 element
220 chassis
224 tray
230 slide mechanism
238 radius limiters
256 frame members
258 hinges
260 middle portion
262 openings
264 side portions
266 cover
268 latches
270 radius limiters
276 pathway
278 upper level
280 lower level
284 radius limiters
286 cable mounts
288 dovetail
290 opening
292 block
294 bar
296 fasteners
310 element
330 slide mechanism
332 wheels
334 wire
336 wire
340 first part
342 second part
344 third part
410 element
420 radius limiter
430 friction members
500 universal mounting mechanism
502 universal mounting bracket
504 locking spring
506 release handle
508 cover
510 element
512 latch openings
514 front portion of the mounting bracket
516 mounting tabs
518 rear portion of the mounting bracket
520 bracket channel
522 deflection ramp
524 end portion of the locking spring
526 perpendicular locking face
528 angular insertion face
530 front end
532 inner front face
534 grip portion
536 deflection tab
538 rear end of the release handle
540 positive stop
542 stop face
544 slide mechanism
545 fasteners

What is claimed is:

1. A telecommunications chassis removably mountable to a telecommunications fixture defining a latch opening, the telecommunications chassis comprising:
a locking spring having a laterally movable flexible portion configured to snap into the latch opening for mounting the telecommunications chassis to the telecommunications fixture; and
a release mechanism configured to cause the portion of the locking spring that is within the latch opening to flex laterally out of the latch opening for releasing the telecommunications chassis from the telecommunications fixture.

2. A telecommunications chassis according to claim 1, wherein the release mechanism includes a release handle slidably mounted to the telecommunications chassis, the release handle configured for being pulled in a rearward-to-forward direction, wherein the release handle is configured to laterally move the flexible portion of the locking spring that is in the latch opening such that when the release handle is slid with respect to the telecommunications chassis in a rearward-to-forward direction, the release handle causes the portion of the locking spring that is within the latch opening to flex laterally out of the latch opening for releasing the telecommunications chassis from the telecommunications fixture.

3. A telecommunications chassis according to claim 2, further comprising a deflection structure defined within the telecommunications chassis, wherein the release handle is configured to interact with the deflection structure defined within the telecommunications chassis for laterally moving the flexible portion of the locking spring that is in the latch opening such that when the release handle is slid with respect to the telecommunications chassis in a rearward-to-forward direction, the release handle interacts with the deflection structure defined within the telecommunications chassis to cause the portion of the locking spring that is within the latch opening to flex laterally out of the latch opening for releasing the telecommunications chassis from the telecommunications fixture.

4. A telecommunications chassis according to claim 1, wherein the release mechanism is manually activated.

5. A telecommunications chassis according to claim 2, wherein the release handle includes a grip portion adjacent a front end of the release handle for slidably pulling the release handle.

6. A telecommunications chassis according to claim 3, further comprising two of the locking springs, two of the release handles, and two of the deflection structures, one set configured to be mounted to a right side and one set configured to be mounted to a left side of the telecommunications chassis.

7. A telecommunications chassis according to claim 1, wherein the telecommunications fixture is a telecommunications rack configured to receive the telecommunications chassis in a vertically stacked arrangement.

8. A telecommunications chassis according to claim 1, further including a slidable tray housing fiber optic equipment.

9. A telecommunications chassis according to claim 1, wherein the latch opening is defined by an elongate front portion of a mounting bracket that is removably mounted to the telecommunications fixture, wherein the telecommunications chassis further defines a bracket channel for receiving the elongate front portion of the mounting bracket.

10. A telecommunications chassis according to claim 2, wherein the locking spring is fixedly mounted to the telecommunications chassis in a front-to-back direction and the release handle is configured to move relative to the locking spring.

11. A method of using a telecommunications chassis, the method comprising:
mounting a telecommunications chassis to a mounting bracket on a telecommunications rack by inserting an elongate front portion of the mounting bracket into a bracket channel defined by the telecommunications chassis;
laterally flexing a locking spring of the telecommunications chassis to snap-fit at least a portion of the locking spring into a latch opening defined on the mounting bracket for mounting the telecommunications chassis to the telecommunications fixture; and
activating a release mechanism on the telecommunications chassis to cause the portion of the locking spring that is within the latch opening to flex laterally out of the latch opening for releasing the telecommunications chassis from the mounting bracket.

12. A method according to claim 11, wherein the step of activating the release mechanism comprises pulling a release handle on the telecommunications chassis along a rearward-to-forward direction to deflect the locking spring out of the latch opening.

13. A method according to claim 12, wherein the release handle defines a deflection tab that interacts with a deflection ramp provided on the telecommunications chassis for laterally moving the locking spring out of the latch opening of the mounting bracket when the release handle is slid along the rearward-to-forward direction with respect to the telecommunications chassis, wherein the release handle is configured such that pulling of the release handle in a rearward-to-forward direction relative to the telecommunications chassis causes the deflection tab of the release handle to interact with the deflection ramp of the chassis and move the deflection tab laterally, and wherein lateral movement of the deflection tab causes the deflection tab to contact the locking spring and to cause the portion of the locking spring that is within the latch opening to flex laterally out of the latch opening for releasing the telecommunications chassis from the mounting bracket.

14. A method according to claim 11, further comprising re-coupling the telecommunications chassis to the mounting bracket such that the front portion of the mounting bracket is re-inserted into the bracket channel of the telecommunications chassis and the locking spring is laterally flexed to snap-fit at least a portion of the locking spring into the latch opening.

15. A method according to claim 11, further comprising mounting the telecommunications chassis such that the front portion of one of two mounting brackets is slid into a bracket channel defined on a right side of the telecommunications chassis and the front portion of the other of the two mounting brackets is slid into a bracket channel defined on a left side of the telecommunications chassis.

16. A method according to claim 11, wherein the telecommunications fixture is a telecommunications rack configured to receive telecommunications chassis in a vertically stacked arrangement.

17. A method according to claim 11, wherein the telecommunications chassis includes a slidable tray housing fiber optic equipment.
